(19) United States
(12) Patent Application Publication
(10) Pub. No.: US 2026/0212450 A1
(43) Pub. Date: Jul. 23, 2026

(54) DATA PROCESSING USING INTER-CHIP COMMUNICATION FOR COMPUTING SYSTEMS AND APPLICATIONS

(71) Applicant: NVIDIA Corporation, Santa Clara, CA (US)

(72) Inventors: Ziheng Li, Shenzhen (CN); Rongrong Zhou, Shenzhen (CN)

(21) Appl. No.: 19/035,646

(22) Filed: Jan. 23, 2025

(30) Foreign Application Priority Data
Jan. 20, 2025 (CN) 202510088811X

(51) Int. Cl. G06T 5/50; G06T 1/60

(52) U.S. Cl. CPC G06T 5/50; G06T 1/60; G06T 2207/20221

(57) ABSTRACT

In various examples, data processing using inter-chip communication for computing systems and applications is described herein. Systems and methods described herein may use interfaces that transmit data between chips to perform one or more processing tasks, such as image stitching, image cropping, format conversion, and/or any other processing task. For instance, image data obtained using image or camera sensors may be stored in source buffers of a first chip. The image data may then be associated with descriptors used to transmit the image data from the source buffers to a destination buffer of a second chip. For instance, a descriptor may indicate at least an identifier of a source buffer, an address within the source buffer, an address within the destination buffer, and a length of data being transmitted. As described herein, in some examples, transmitting the image data using the descriptors may cause the processing task(s) to be performed.

### BACKGROUND

In various computing systems—such as semi-autonomous and/or autonomous driving or robotics systems—a single chip (e.g., a system-on-a-chip (SoC)) may struggle to meet computational demands. As such, many manufacturers of such computing systems may employ dual or quad chips to collaborate and pool computing resources for various tasks. For a first example, and with regard to image processing, a computing system may use a first chip to process image data obtained using one or more image or camera sensors and a second chip to manage algorithms executed with respect to the image data. For a second example, and again with regard to image processing, a computing system may use a first chip to perform image stitching on image data obtained using multiple image or camera sensors and a second chip to cause presentation of the stitched images. However, due to format differences among modules and/or diverse requirements with regard to chips, additional processing tasks arise which may increase the end-to-end latency of such computing systems. For instance, and for the second example, data processing tasks, image stitching processing tasks, and format conversion tasks may increase the latency of the computing system.

As such, manufacturers may use various techniques to attempt to improve the performance of the computing systems, such as to reduce the overall latency. For instance, some computing systems are optimized with regard to drivers that transmit data between chips, such as by using efficient packet handling to configure advanced prefetching of data or using streamlined protocols that reduce resources during data transmission. Additionally, some computing systems are optimized with regard to pipeline processing, such as by using power management settings to disable power management features that introduce latency during idle periods or using caching and compressing techniques to store frequently accessed data locally. However, even with using these optimization techniques, some computing systems may still include end-to-end latencies that are inadequate for the tasks for which the computing systems are manufactured.

### SUMMARY

Embodiments of the present disclosure relate to data processing using inter-chip communication for computing systems and applications. Systems and methods described herein may use interfaces that transmit data between chips to perform one or more processing tasks, such as image stitching, image cropping, format conversion, and/or any other processing task. For instance, image data obtained using image sensors may be stored in source buffers of a first interface of a first chip. The image data may then be associated with descriptors used to transmit the image data from the source buffers to a destination buffer of a second interface of a second chip. For instance, a descriptor may indicate at least an identifier of a source buffer, an address within the source buffer, an address within the destination buffer, and a length of data being transmitted. As described herein, in some examples, transmitting the image data using the descriptors may cause the processing task(s) to be performed, such as stitching the images represented by the image data.

In contrast to conventional systems, the systems of the present disclosure, in various embodiments, perform one or more image processing tasks—such as image stitching—using data transmission techniques rather than using separate hardware, software, engines, modules, and/or other processing components. This may reduce the amount of computing resources required to process the image data and/or may reduce the overall latency of a computing system. For example, the conventional systems may use a first chip to obtain image data from multiple image or camera processors, perform image processing (e.g., image stitching), and then transmit image data representing the processed images to a second chip that displays the processed images. In contrast, the systems of the present disclosure may use a first chip to obtain the image data from multiple image or camera processors, use interfaces to perform the image processing during data transmission, and then use the second chip to display the processed images.

### BRIEF DESCRIPTION OF THE DRAWINGS

The present systems and methods for data processing using inter-chip communication for computing systems and applications are described in detail below with reference to the attached drawing figures, wherein:

FIG. 1 illustrates an example data flow diagram for a process of performing data processing using transmission between chips, in accordance with some embodiments of the present disclosure;

FIG. 2 illustrates an example of a machine using image sensors to obtain image data, in accordance with some embodiments of the present disclosure;

FIGS. 3A-3B illustrate an example of performing vertical stitching when transmitting image data between chips, in accordance with some embodiments of the present disclosure;

FIGS. 4A-4C illustrate an example of performing horizontal stitching when transmitting image data between chips, in accordance with some embodiments of the present disclosure;

FIGS. 5A-5B illustrate examples of additional processing that may be performed to images using one or more of the processes described herein, in accordance with some embodiments of the present disclosure;

FIG. 6A illustrates a flow diagram showing a method for using data transmission to perform image stitching, in accordance with some embodiments of the present disclosure;

FIG. 6B illustrates a flow diagram showing a method for using descriptors to perform one or more processing tasks when transmitting data between chips, in accordance with some embodiments of the present disclosure;

FIG. 7A is an illustration of an example autonomous vehicle, in accordance with some embodiments of the present disclosure;

FIG. 7B is an example of camera locations and fields of view for the example autonomous vehicle of FIG. 7A, in accordance with some embodiments of the present disclosure;

FIG. 7C is a block diagram of an example system architecture for the example autonomous vehicle of FIG. 7A, in accordance with some embodiments of the present disclosure;

FIG. 7D is a system diagram for communication between cloud-based server(s) and the example autonomous vehicle of FIG. 7A, in accordance with some embodiments of the present disclosure;

FIG. 8 is a block diagram of an example computing device suitable for use in implementing some embodiments of the present disclosure; and

FIG. 9 is a block diagram of an example data center suitable for use in implementing some embodiments of the present disclosure.

### DETAILED DESCRIPTION

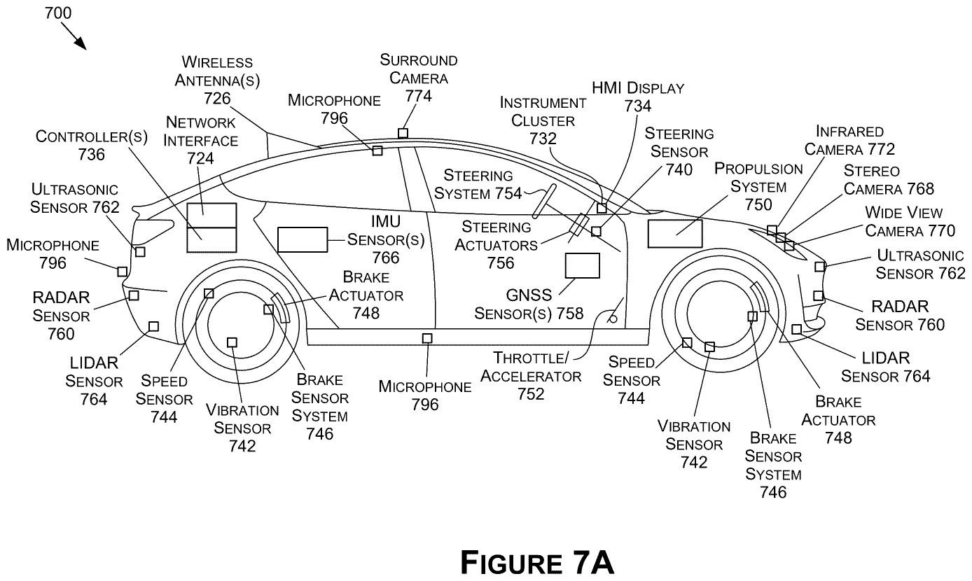

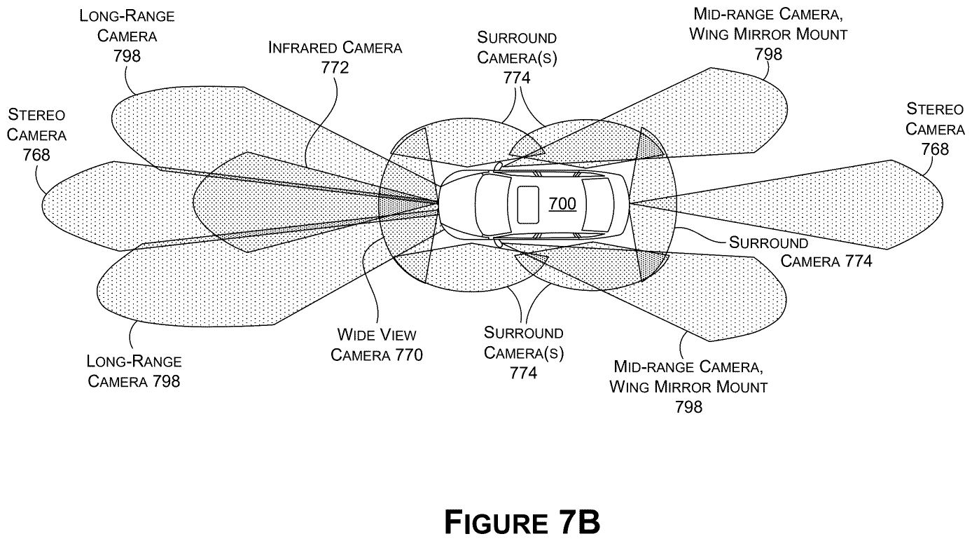

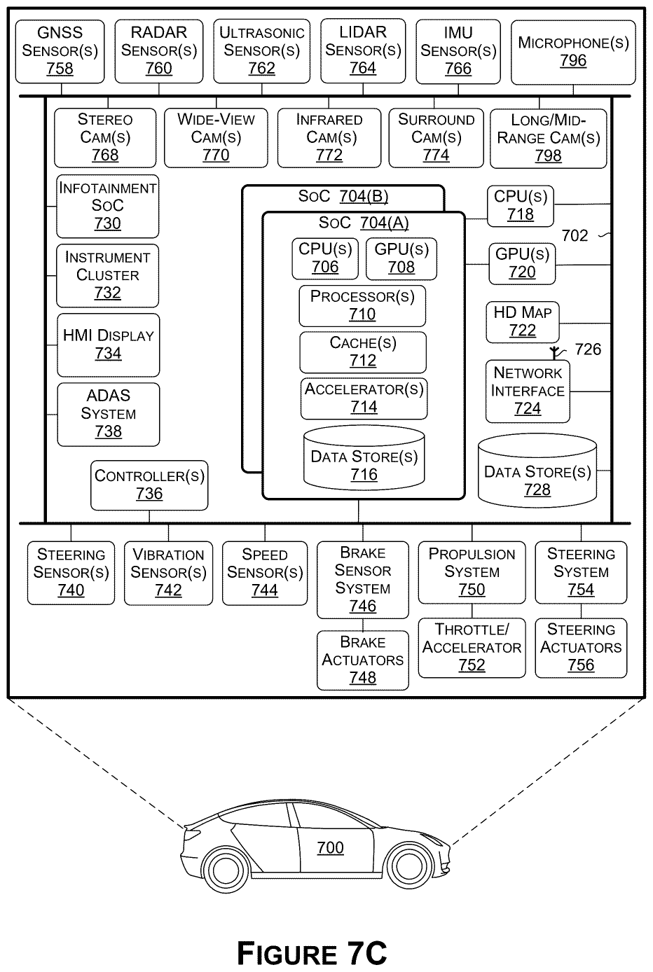

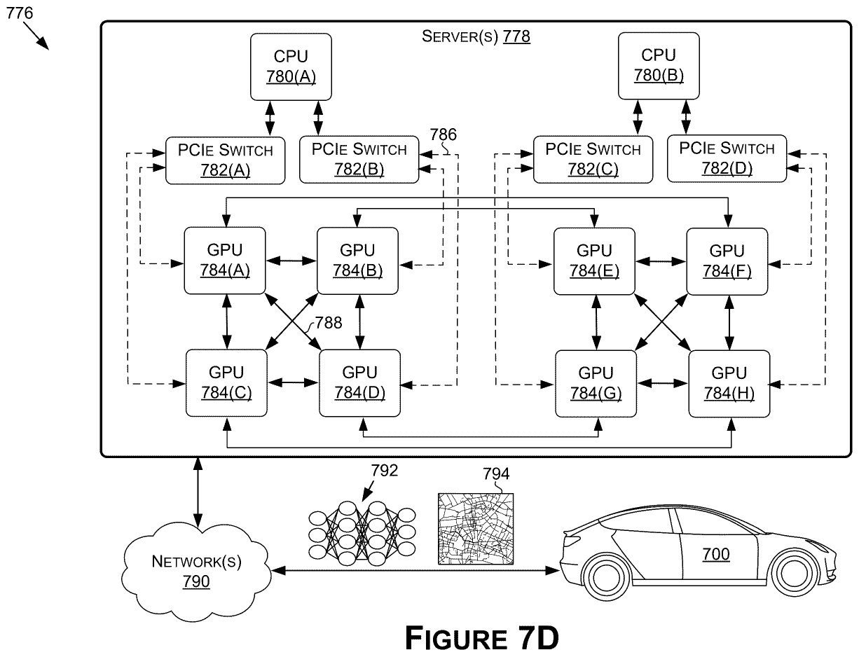

Systems and methods are disclosed for data processing using transmission between chips for systems and applications. Although the present disclosure may be described with respect to an example autonomous or semi-autonomous vehicle or machine 700 (alternatively referred to herein as “vehicle 700,” “ego-vehicle 700,” “ego-machine 700,” or “machine 700,” an example of which is described with respect to FIGS. 7A-7D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to data processing and/or data transmission in autonomous or semi-autonomous systems and applications, this is not intended to be limiting, and the systems and methods described herein may be used in augmented reality, virtual reality, mixed reality, robotics, security and surveillance (e.g., in smart cities, parking garages, venue or event spaces, shopping malls, etc.), autonomous or semi-autonomous machine applications, and/or any other technology spaces where data processing and/or data transmission may occur.

For instance, a system may receive image data obtained using one or more image sensors. As described herein, in some examples, the image sensors may be associated with and/or located on an object, such as a machine (e.g., a robot, a vehicle, a semi-autonomous vehicle, an autonomous vehicle, etc.), a structure or building (e.g., a house, a business, a company, a parking garage etc.), a smart cities applications (e.g., using a local and/or remotely located server(s) or data center to process data from various cameras distributed around a geographic area), and/or any other type of object and/or environment. For example, if the image sensors are located on a machine, then the image or camera sensors may be configured to capture different portions of the environment at least partially surrounding the machine, such as the front, the right side, the back, the top, the bottom, and the left side of the machine. The system(s) may then be configured to process the image data using chips that are associated with performing various processing tasks, such as image stitching, image cropping, format conversion, and/or any other type of processing task. Additionally, the chips may be configured such that at least a portion of the processing is performed using the transmission of the data between the chips.

For instance, the first chip may store the image data using one or more memories—such as one or more buffer memories—which may also be referred to as the “source memories” or the “source buffers.” In some examples, the respective image data generated by each of the image sensors may be stored in a respective source memory. For example, if the image data is obtained using four image sensors, then the first chip may store first image data obtained using a first image sensor in a first source memory, second image data obtained using a second image sensor in a second source memory, third image data obtained using a third image sensors in a third source memory, and fourth image data obtained using a fourth image sensor in a fourth source memory. However, two or more individual sensors may share a source memory or other memory type for storage of image data. In some examples, the source memories may be associated with a component of the first chip. For example, the source memories may be included as a part of a first dynamic random access memory (DRAM) of the first chip.

The first chip may then be configured to transmit the image data from the source buffers to a second chip. As described herein, the second chip may store the image data using at least one memory—such as a buffer memory—which may also be referred to as the “destination memory” or the “destination buffer.” Additionally, in some examples, the destination memory may be associated with a component of the second chip, such as a second interface for transmitting data. For example, the destination memory may be included within second DRAM of the second chip. In order to improve the performance of the system(s), such as by reducing the amount of computing resources required for data processing and/or reducing the latency required for data processing, the system(s) may be configured to perform one or more processing tasks using the transmission of the image data between the chips. For instance, in some examples, the system(s) may be configured to perform at least image stitching using the transmission of the image data between the chips.

For instance, the system(s) (and/or the first chip) may generate descriptors for and/or associate the descriptors with the image data stored in the source memories, the source memories, and/or channels used to transmit the image data between the chips. As described herein, a descriptor may include at least an identifier associated with the descriptor, a source address within a source memory for which data is to be retrieved, a destination address within the destination memory for which the data is to be stored, a size (e.g., a packet size) associated with the data, and/or any other information that may be used to transmit the data. Additionally, the information indicated by the descriptors may be specific to a type of processing that is being performed based on the transmitting of the data. For example, different data arrangements in descriptors may be used based on whether image stitching includes performing vertical stitching, horizontal stitching, grid stitching, and/or any other type of stitching.

For a first example, to perform vertical stitching, the system(s) (e.g., the first chip) may associate each of the source memories with a respective descriptor. For instance, and using the example above with the four source memories associated with the four image sensors, the system(s) may associate each of the source memories, the respective image data stored in each of the source memories, and/or the respective channel used to transmit the image data stored in each of the source memories with a respective descriptor. Additionally, and for a descriptor, a source address may be associated with an entirety of the source memory and a destination address may be associated with a portion of the destination memory. For instance, a first descriptor associated with the first source memory may cause the first image data to be stored in a first portion of the destination memory, a second descriptor associated with the second source memory may cause the second image data to be stored in a second portion of the destination memory that is associated with a vertical alignment with respect to the first image data, a third descriptor associated with the third source memory may cause the third image data to be stored in a third portion of the destination memory that is associated with a vertical alignment with respect to the second image data, and a fourth descriptor associated with the fourth source memory may cause the fourth image data to be stored in a fourth portion of the destination memory that is associated with a vertical alignment with respect to the third image data.

For a second example, to perform horizontal stitching and/or grid stitching, the system(s) (e.g., the first chip) may associate each row of data of the source memories with a respective descriptor. For instance, and for a descriptor, a source address may indicate a row of a source memory, a destination address may indicate at least a portion of a row of the destination memory, and a packet size may indicate a number of pixels in the row. As such, in some examples, a number of descriptors used for performing such a transmission may depend on one or more factors, such as a resolution associated with the image data. For a first example, if the resolution is 1280×720, then each of the source memories and/or the image data stored in each of the source memories may be associated with 720 descriptors, where each descriptor is used to transmit a row of pixel data. For a second example, if the resolution is 2560×1440, then each of the source memories and/or the image data stored in each of the source memories may be associated with 1440 descriptors, where each descriptor is again used to transmit a row of pixel data.

The system(s) may then use the descriptors when transmitting the image data from the first chip to the second chip. For a first example, to perform the vertical stitching, the descriptors may be used to transmit the image data from the source memories to the destination memory using channels. For instance, the first descriptor may be used to transmit the first image data from the first source memory to the first portion of destination memory using a first channel, the second descriptor may be used to transmit the second image data from the second source memory to the second portion of the destination memory using a second channel, and/or so forth. For a second example, to perform horizontal stitching and/or grid stitching, the descriptors may be used to transmit rows of pixel data from the source memories to the destination memory using the channels. For instance, and as described in more detail herein, the image data may be transmitted starting at the first row of pixels from each source memory and moving in order to the last row of pixels from each source memory. In either example, the image data stored in the respective source memories may be transmitted concurrently together using the channels.

While these examples describe using the transmitting of data to perform image stitching, in other examples, the transmitting of data may be used to perform other types of processing tasks. For a first example, and for image cropping, the descriptors may indicate portions of the image data that represent portions of the images that are to be cropped. This way, using the descriptors, the portions of the image data may be transmitted without transmitting other portions of the image data such that the image data stored in the destination memory represents the cropped images. For a second example, and for format conversion, the descriptors may be associated with performing the conversion, such as from block linear to pitch linear conversion or pitch linear to block linear conversion. In other words, the descriptors may be used to perform various types of processing with respect to the images during the transmission between the chips.

In some examples, the system(s) (e.g., the second chip) may then perform one or more operations using the image data stored in the destination memory. For instance, in some examples, if the image data represents the stitched images, then the system(s) may display the stitched images using one or more display devices. For example, if the image sensors are associated with a machine and capture image data representing the environment at least partially surrounding the machine, by performing one or more of the processes described herein, the system(s) may display the stitched images representing the surrounding environment. Additionally, or alternatively, in some examples, the image data stored in the destination memory may be processed to perform one or more additional processing tasks, such as object detection, object tracking, object classification, event detection, event classification, and/or any other type of processing task.

In some examples, by performing one or more of the processes described herein, the system(s) is able to perform one or more processing tasks using the transmission of data between the chips rather than separate processing components, such as separate hardware and/or software. As described herein, this may provide various improvements over conventional systems, such as reducing the amount of computing resources needed to perform the processing task(s) on the chips and/or reducing the overall processing latency associated with the chips.

While the examples herein describe obtaining and/or processing image data from four image or camera sensors, in other examples, similar processes may be used with respect to obtaining and/or processing image data from any number of image sensors (e.g., one image sensor, two image sensors, ten image sensors, etc.). Additionally, while the examples herein describe processing image data from image or camera sensors, in other examples, similar processes may be used to process other types of sensor data from other types of sensors. For example, similar processes may be used to process LiDAR data from one or more LiDAR sensors, RADAR data from one or more RADAR sensors, one or more ultrasonic sensors, and/or the like.

In some embodiments, the systems and methods described herein may be performed within a simulation environment (e.g., NVIDIA's DriveSIM, ISAAC GYM, and/or ISAAC SIM) using simulated data (e.g., simulated sensor data of simulated sensors of a virtual or simulated machine). For example, simulated sensor data and/or map data (simulated or real) may be used to perform various operations within the simulation environment, such as to generate the simulation data and/or operate a machine. These simulated operations may be used to test performance of the underlying algorithms, systems, and/or processes prior to deploying them in the real-world. In some instances, the simulation may be used to generate synthetic training data—e.g., training data including images that are configured to be stitched together, etc.—so that the synthetic training data (in addition to or alternatively from real-world data) may then be processed to perform one or more of the operations described herein.

In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs—such as, without limitation, REST APIs.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)-which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

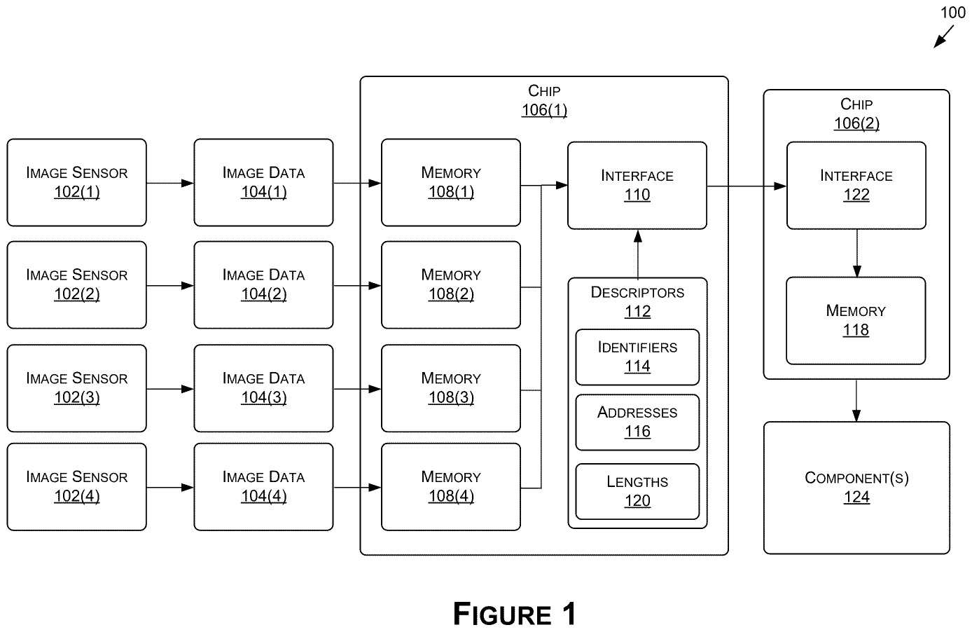

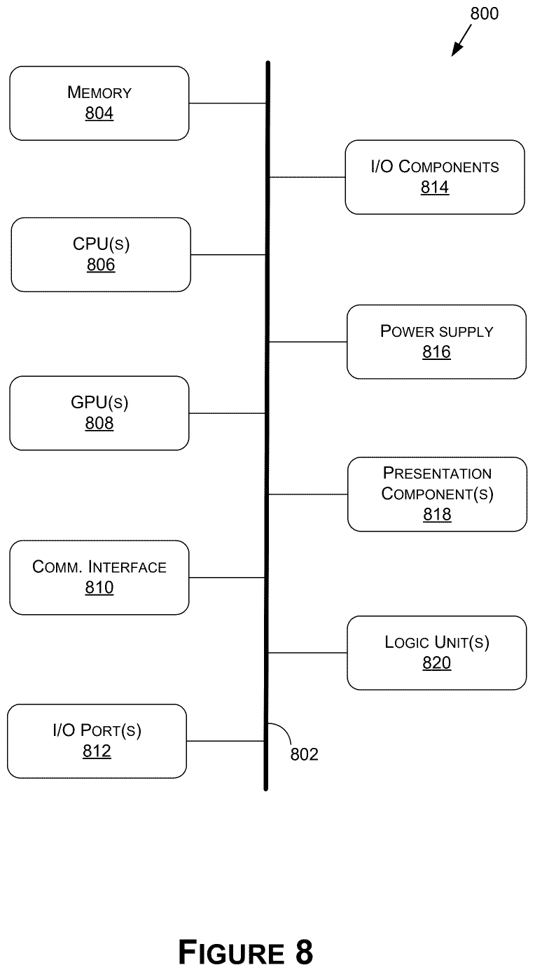

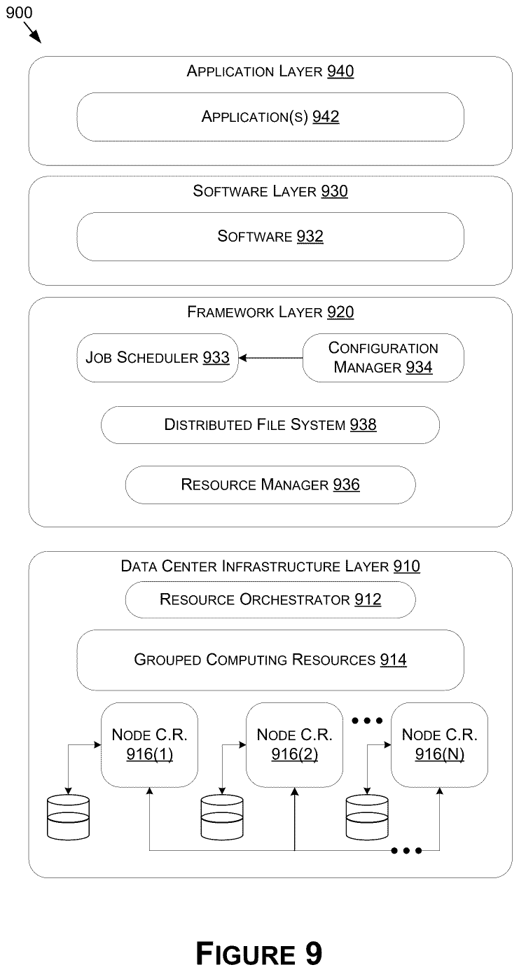

With reference to FIG. 1, FIG. 1 illustrates an example data flow diagram for a process 100 of performing data processing using transmission between chips, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 700 of FIGS. 7A-7D, example computing device 800 of FIG. 8, and/or example data center 900 of FIG. 9.

For instance, the process 100 may include using image or camera sensors 102(1)-(4) (also referred to singularly as “image sensor 102” or in plural as “image sensors 102”) to obtain image data 104(1)-(4) (also referred to as “image data 104”). As described herein, in some examples, the image sensors 102 may be associated with and/or located on an object, such as a machine (e.g., a robot, a vehicle, a semi-autonomous vehicle, an autonomous vehicle, etc.), a structure (e.g., a house, a business, a company, a parking garage, etc.), and/or any other type of object, and/or may be associated with an environment (e.g., a city, a park, a geographic region, a road network, etc.). For example, if the image sensors 102 are located on a machine (e.g., an example autonomous vehicle 700), then the image sensors 102 may be configured to capture different portions of the environment at least partially surrounding the machine, such as the front, the right side, the back, and the left side of the machine. As described in more detail herein, the image sensor(s) 102 may capture the image data 104 representing the environment at least partially surrounding the machine to perform one or more operations, such as providing images represented by the image data 104 to one or more users of the machine and/or for processing to perform one or more tasks.

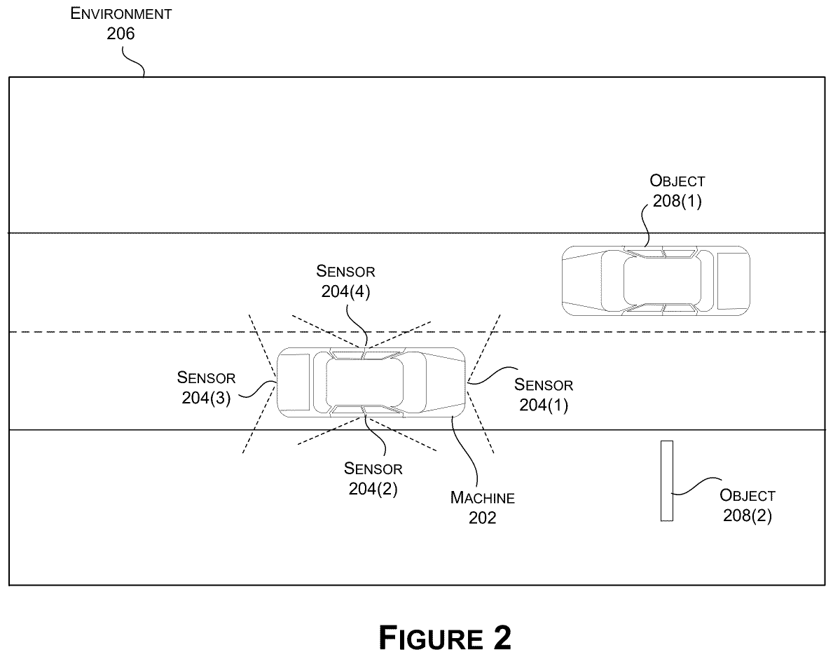

For instance, FIG. 2 illustrates an example of a machine 202 using image sensors 204(1)-(4) (also referred to singularly as “image sensor 204” or in plural as “image sensors 204”) (which may include, and/or be similar to, the image sensors 102) to obtain image data, in accordance with some embodiments of the present disclosure. As shown, the machine 202 may use the image sensors 204 to generate the image data representing an environment 206 that at least partially surrounds the machine 202. The machine 202 may then be configured to process the image data using one or more of the processes described herein, such as to generate stitched images representing the surrounding environment 206. This way, one or more users of the machine 202 are able to quickly view the surrounding environment 206, such as to identify objects 208(1)-(2) located proximate to the machine 202.

Referring back to the example of FIG. 1, the process 100 may include processing the image data 104 using chips 106(1)-(2) (also referred to singularly as “chip 106” or in plural as “chips 106”) that are associated with performing various processing tasks, such as image stitching, image cropping, format conversion, and/or any other type of processing task. For instance, the process 100 may include storing the image data 104 in memories 108(1)-(4) (also referred to singularly as “source memory 108” or in plural as “source memories 108”) of the first chip 106(1). As described herein, in some examples, the source memories 108 may include a specific type of memory, such as buffer memory (and/or any other type of memory) that is configured to temporarily store the image data 104 before being transmitted to the second chip 106(2). In some examples, the source memories 108 may be associated with a component of the first chip 106(1), such as included as part of a first DRAM of the first chip 106(1). In such an example, the interface 110 may include a driver—such as a PCIe driver (and/or any other type of driver)—that is able to access the source memories 108 for transmitting the data.

The process 100 may then include generating descriptors 112 for and/or associating the descriptors 112 with the image data 104, the source memories 108, and/or channels used to transmit the image data 104. As shown, the descriptors 112 may include information associated with transmitting the image data 104 from the first chip 106(1) to the second chip 106(2). For instance, a descriptor 112 may include at least an identifier 114 associated with the descriptor 106, a source address 116 associated with where data is stored in a source memory 108, a destination address 116 associated with where the data is going to be stored in a destination memory 118 of the second chip 106(2), and a length 120 (e.g., a packet size) associated with the data being transmitted. Additionally, the descriptors 112 may include any type of descriptors, such as descriptors that are configured to mount on a direct memory access (DMA) of the interface 110.

As described herein, an identifier 114 may include, but is not limited to, a numerical identifier, an alphabetic identifier, an alphanumeric identifier, a symbol, a code, and/or any other type of identifier that may be used to identify a descriptor 112. Additionally, a source address 116 may indicate a location (e.g., a starting location) within a source memory 108 for which image data 104 being transmitted is located. Furthermore, a destination address 116 may indicate a location (e.g., a starting location) within the destination memory 118 for which the image data 104 is being stored after being transmitted. Moreover, a length 120 may indicate the packet size associated with the image data 104 being transmitted. As described in more detail herein, in some examples, image data 104 representing entire images may be transmitted using a single descriptor 112. However, in other examples, image data 104 representing portions of images may be transmitted using a single descriptor 112, such as rows of pixels.

In some examples, the descriptors 112 may be generated to include information that is related to the type of processing task being performed during the transmitting of the image data 104 from the first chip 106(1) to the second chip 106(2). For instance, in some examples, such as when the processing task includes vertically stitching images, image data 104 representing each image may be represented using a respective descriptor 112. Additionally, in some examples, such as when the processing task includes horizontally stitching images and/or stitching the images in a grid pattern, image data 104 representing each portion of the images may be represented using a respective descriptor 112. For examples, image data 104 representing each row of pixels of images may be represented using a respective descriptor 112.

The process 100 may then include using the descriptors 112 to transmit the image data 104 via the interface 110 and an interface 122 of the second chip 106(2) from the source memories 108 to the destination memory 118. In some examples, the interface 122 may include a similar type of interface as the interface 110. For instance, the interface 122 may include a PCIe interface (and/or any other type of interface—where the destination memory 118 is associated with the interface 122. By using the descriptors 112 to transmit the image data 104, the image data 104 may be stored in the destination memory 118 such that the processing task was performed on the image data 104. For example, the image data 104 may be stored in the destination memory 118 such that the images represented by the image data 104 were vertically stitched, horizontally stitched, stitched using a grid pattern, and/or stitched using any other type of technique.

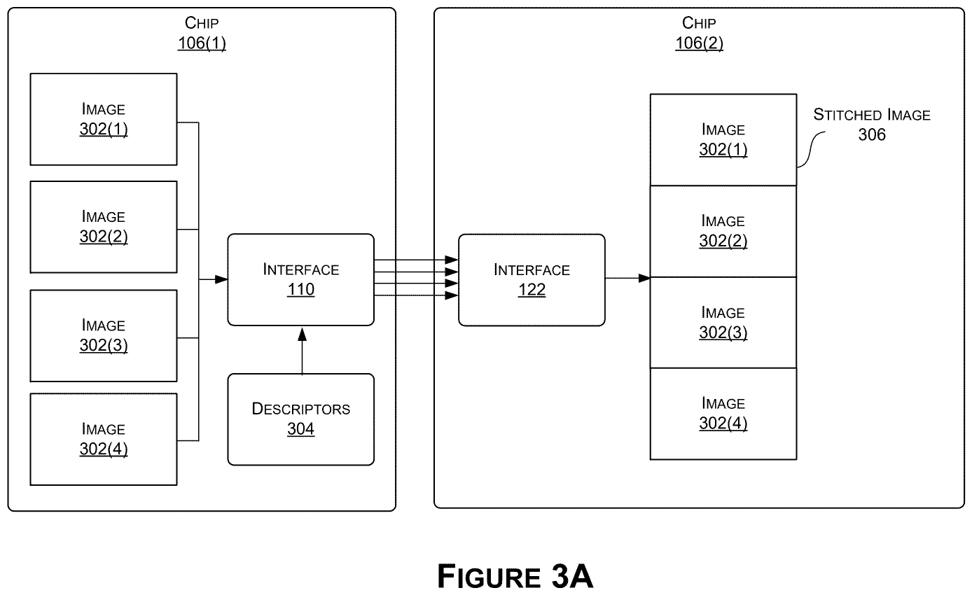

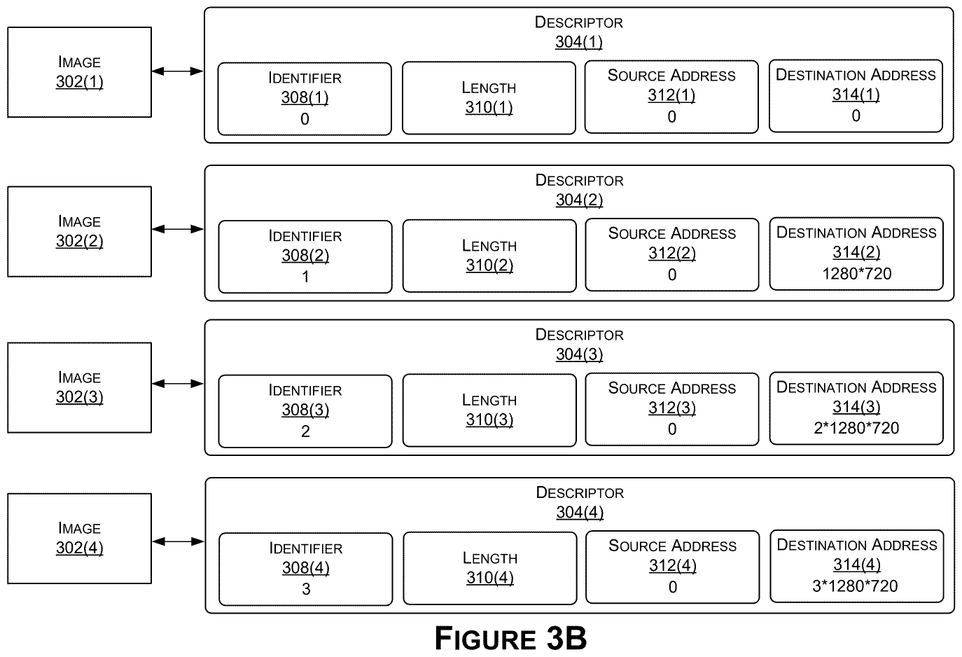

For more details, FIGS. 3A-3B illustrate an example of performing vertical stitching when transmitting image data between the chips 106, in accordance with some embodiments of the present disclosure. While the examples illustrated and discussed with regard to FIGS. 3A-3B use image data representing a specific resolution, which includes 1280×720, in other examples, similar processes may be performed using image data that includes any other resolution.

As shown by the example of FIG. 3A, the first chip 106(1) may store image data representing images 302(1)-(4) (also referred to singularly as “image 302” or in plural as “images 302”) in the source memories 108 (which are not illustrated for clarity reasons). For instance, in some examples, the first image sensor 204(1) may obtain first image data representing the first image 302(1) stored in the first source memory 108(1), the second image sensor 204(2) may obtain second image data representing the second image 302(2) stored in the second source memory 108(2), the third image sensor 204(3) may obtain third image data representing the third image 302(3) stored in the third source memory 108(3), and the fourth image sensor 204(4) may obtain fourth image data representing the fourth image 302(4) stored in the fourth source memory 108(4).

The first chip 106(1) may also associate the images 302 with descriptors 304 (which may include, and/or be similar to, the descriptors 112) used for generating a stitched image 306. For instance, and as shown by the example of FIG. 3B, since this is vertical stitching, the first descriptor 304(1) associated with the first image 302(1) may include a first identifier 308(1) of 0 since it is the first descriptor, a first length 310(1) indicating a first amount of data that needs to be transmitted, a first source address 312(1) of 0 which is where the first image data is stored in the first source memory 108(1), and a first destination address 314(1) of 0 which is where the first image data is to be stored in the destination memory 118. The second descriptor 304(2) associated with the second image 302(2) may include a second identifier 308(2) of 1 since it is the second descriptor, a second length 310(2) indicating a second amount of data that needs to be transmitted, a second source address 312(2) of 0 which is where the second image data is stored in the second source memory 108(2), and a second destination address 314(2) of 1280×720 which is where the second image data is to be stored in the destination memory 118.

Additionally, the third descriptor 304(3) associated with the third image 302(3) may include a third identifier 308(3) of 2 since it is the third descriptor, a third length 310(3) indicating a third amount of data that needs to be transmitted, a third source address 312(3) of 0 which is where the third image data is stored in the third source memory 108(3), and a third destination address 314(3) of 2×1280×720 which is where the third image data is to be stored in the destination memory 118. Furthermore, the fourth descriptor 304(4) associated with the fourth image 302(4) may include a fourth identifier 308(4) of 3 since it is the fourth descriptor, a fourth length 310(4) indicating a fourth amount of data that needs to be transmitted, a fourth source address 312(4) of 0 which is where the fourth image data is stored in the fourth source memory 108(4), and a fourth destination address 314(4) of 3×1280×720 which is where the fourth image data is to be stored in the destination memory 118.

As described above, in the example of FIGS. 3A-3B, the images 302 may include a specific resolution, such as 1280×720. As such, the destination addresses 314(1)-(4) start at 0 and continue to increase by 1280×720 for each of the images in order to cause the images 302 to be offset within the destination memory 118 to cause the vertical stitching. However, in other examples where the resolution of the images is different, such as being 2560×1440 (and/or any other resolution), the destination address may again start at 0 (and/or any other address location within the destination memory 118), but then again increase based on the resolution of the images. By using such a technique, the chips 106 are able to stitch the images 302 together vertically when performing the transmission of the image data.

For instance, and referring back to the example of FIG. 3A, the first chip 106(1) may use the descriptors 304 to transmit the image data representing the images 302 to the second chip 106(2). In some examples, such as to reduce the latency, the first chip 106(1) may use multiple channels to perform the transmission, where the channels are represented by the arrows between the interface 110 and the interface 122. For instance, a first channel may transmit the first image data using the first descriptor 304(1), a second channel may transmit the second image data using the second descriptor 304(2), a third channel may transmit the third image data using the third descriptor 304(3), and a fourth channel may transmit the fourth image data using the fourth descriptor 304(4). As a result of performing such processes using the descriptors 304, the stitched image 306 may include the images 302 vertically aligned with one another.

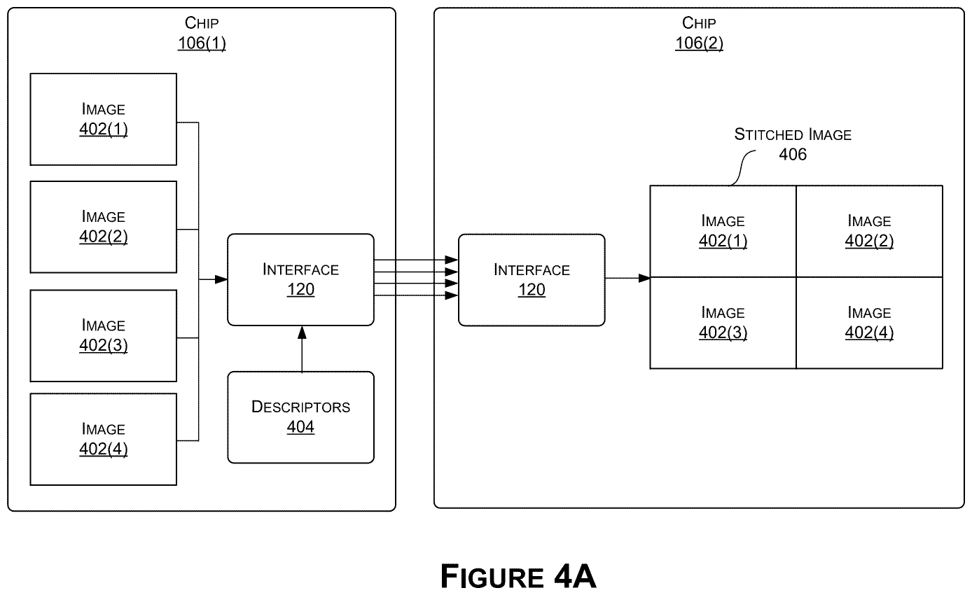

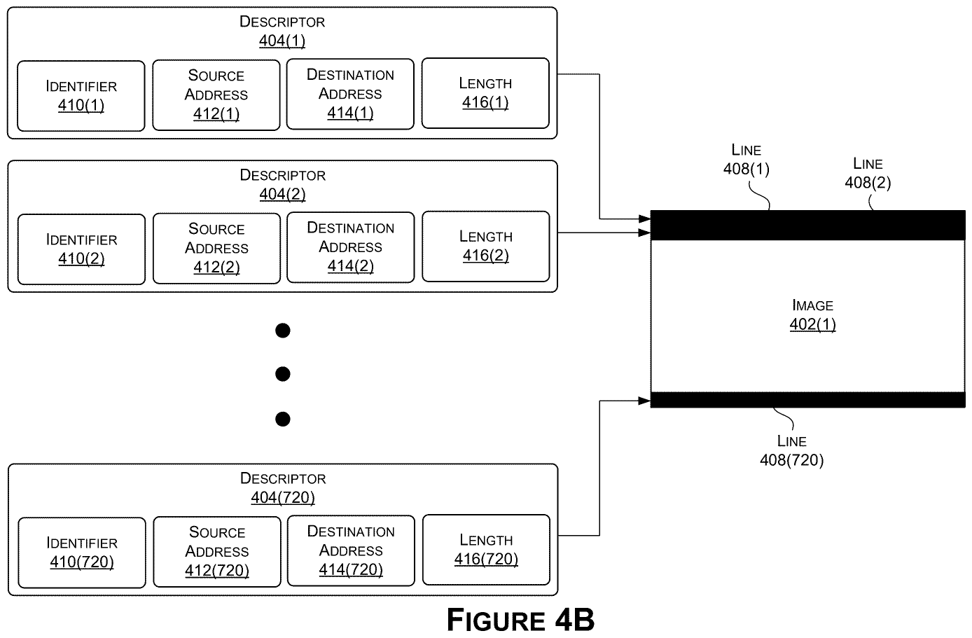

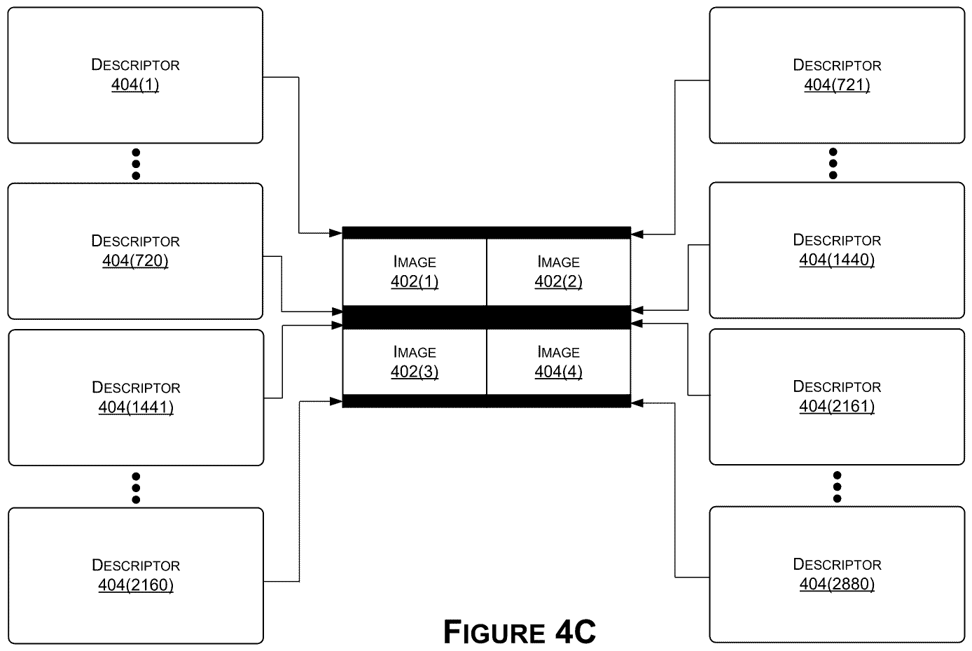

FIGS. 4A-4C illustrate an example of performing horizontal stitching when transmitting image data between the chips 106, in accordance with some embodiments of the present disclosure. While the examples illustrated and discussed with regard to FIGS. 4A-4C again use image data representing a specific resolution, which includes 1280×720, in other examples, similar processes may be performed using image data that includes any other resolution.

As shown by the example of FIG. 4A, the first chip 106(1) may store image data representing images 402(1)-(4) (also referred to singularly as “image 402” or in plural as “images 402”) in the source memories 108 (which are not illustrated for clarity reasons). For instance, in some examples, the first image sensor 204(1) may obtain the first image data representing the first image 402(1) stored in the first source memory 108(1), the second image sensor 204(2) may obtain the second image data representing the second image 402(2) stored in the second source memory 108(2), the third image sensor 204(3) may obtain the third image data representing the third image 402(3) stored in the third source memory 108(3), and the fourth image sensor 204(4) may obtain the fourth image data representing the fourth image 402(4) stored in the fourth source memory 108(4).

The first chip 106(1) may also associate the images 402 with descriptors 404 (which may include, and/or be similar to, the descriptors 112) used for generating a stitched image 406. For instance, and as shown by the example of FIG. 4B, with regard to the first image 402(1) which may again include a resolution of 1280×720, the first image 402(1) may be associated with 720 descriptors 404(1)-(720), where each of the descriptors 404(1)-(720) is associated with a portion of the first image 402(1). For example, the first descriptor 404(1) may be associated with a first row of pixels 408(1) of the first image 402(1), the second descriptor 404(2) may be associated with a second row of pixels 408(2) of the first image 402(2), and/or so forth until the last descriptor 404(720) is associated with a last row of pixels 408(720) of the first image 402(1).

For more details, the first descriptor 404(1) may include a first identifier 410(1) (e.g., 0), a first source address 412(1) that identifies a first portion of the first source memory 108(1) storing data representing the first row of pixels 408(1), a first destination address 414(1) that identifies a first portion of the destination memory 118 for storing the data representing the first row of pixels 408(1), and a first length 416(1) associated with the first row of pixels 408(1). Additionally, the second descriptor 404(2) may include a second identifier 410(2) (e.g., 1), a second source address 412(2) that identifies a second portion of the first source memory 108(1) storing data representing the second row of pixels 408(2), a second destination address 414(2) that identifies a second portion of the destination memory 118 for storing the data representing the second row of pixels 408(2), and a second length 416(2) associated with the second row of pixels 408(2). Furthermore, the last descriptor 404(720) may include a last identifier 410(720) (e.g., 719), a last source address 412(720) that identifies a last portion of the first source memory 108(1) storing data representing the last row of pixels 408(720), a last destination address 414(720) that identifies a last portion of the destination memory 118 for storing the data representing the last row of pixels 408(720), and a last length 416(720) associated with the last row of pixels 408(720).

In some examples, the first image 402(1) may be associated with 720 descriptors 404 since the resolution of the first image 402(1) is 1280×720. For instance, each of the rows of pixels of the first image 402(1) are associated with a respective descriptor 404. In such examples, the source addresses 412(1)-(720) may continue to increase in order to indicate the locations within the first memory 108(1) for which the data representing the row of pixels 408(1)-(720) is located within the first memory 108(1). For example, the first source address 412(1) may include 1280×0×3, the second source address 412(2) may include 1280×1×3, and this may continue to increase until the last source address 412(720) which may include 1280×719×3. Additionally, the destination addresses 414(1)-(720) may also continue to increase in order to indicate the locations within the destination memory 118 for storing the data representing the row of pixels 408(1)-(720). For example, the first destination address 414(1) may include 2560×0×3, the second destination address 414(2) may include 2560×1×3, and this may continue to increase until the last destination address 414(720) which may include 2560×719×3. In these examples, the destination addresses 414(1)-(720) may include 2560 since the stitched image 406 includes a grid shape where two images are horizontally stitched, such that the total length of the stitched image 406 is 2560 pixels horizontally.

Next, and as shown by the example of FIG. 4C, similar processes may be used to associate descriptors 404(721)-(1440) with the second image data representing the second image 402(2). Additionally, the identifiers of the descriptors 404(721)-(1440) may start at 720 and continue to increase until reaching 1439. Furthermore, the source addresses of the descriptors 404(721)-(1440) may start at 1280×0×3, increase to 1280×1×3, and then continue to increase until finally reaching 1280×719×3. Moreover, the destination addresses of the descriptors (721)-(1440) may start at 2560×0×3+1280×3, increase to 2560×1×3+1280×3, and then continue to increase until finally reaching 2560×719×3+1280×3. As shown, the destination addresses include an offset within the destination memory 118 since the second image 402(2) is horizontally stitched to the first image 404(1).

Similar processes may also be used to associate descriptors 404(1441)-(2160) with the third image data representing the third image 402(3). Additionally, the identifiers of the descriptors 404(1441)-(2160) may start at 1440 and continue to increase until reaching 2159. Furthermore, the source addresses of the descriptors 404(1441)-(2160) may start at 1280×0×3, increase to 1280×1×3, and then continue to increase until finally reaching 1280×719×3. Moreover, the destination addresses of the descriptors 404(1441)-(2160) may start at 2560×720×3, increase to 2560×721×3, and then continue to increase until finally reaching 2560×1439×3. As shown, the destination addresses include an offset within the destination memory 118 since the third image 402(3) is vertically stitched to the first image 402(1).

Still, similar processes may also be used to associate descriptors 404(2161)-(2880) with the fourth image data representing the fourth image 402(4). Additionally, the identifiers of the descriptors 404(2161)-(2880) may start at 2160 and continue to increase until reaching 2879. Furthermore, the source addresses of the descriptors 404(2161)-(2880) may start at 1280×0×3, increase to 1280×1×3, and then continue to increase until finally reaching 1280×719×3. Moreover, the destination addresses of the descriptors 404(2161)-(2880) may start at 2560×720×3+1280×3, increase to 2560×721×3+1280×3, and then continue to increase until finally reaching 2560×1439×3+1280×3. As shown, the destination addresses include an offset within the destination memory 118 since the fourth image 402(4) is vertically stitched to the second image 402(2) and horizontally stitched to the third image 402(3).

As further shown by the example of FIGS. 4A-4C, to perform the transmission, the first chip 106(1) may use the descriptors 404 to transmit the image data representing the images 402 to the second chip 106(2). In some examples, such as to reduce the latency, the first chip 106(1) may use multiple channels to perform the transmission, where the channels are represented by the arrows between the interface 110 and the interface 122. Additionally, the descriptors 404(1), 404(721), 404(1441), and 404(2161) may initially be used to transmit the first rows of pixels of the images 402. Next, descriptors associated with the second row of pixels may then be used to transmit the second row of pixels of the images 402. Additionally, this may continue to occur until the descriptors 404(720), 404(1440), 404(2160), and 404(2880) are used to transmit the final rows of pixels of the images 402.

While these examples describe specific values for when the images 402 include a resolution of 1280×720, in other examples, different values may be used when images include other resolutions. For example, if the resolution of images is 2560×1440, then each image may be associated with 1440 descriptors such that the total number of descriptors includes 5760. Additionally, the source addresses of the descriptors may start at 2560×0×3, increase to 2560×1×3, and then continue to increase until finally reaching 2560×1439×3. Furthermore, the destination addresses of the descriptors associated with the first image may start at 5120×0×3, increase to 5120×1×3, and then continue to increase until reaching 5120×1439×3. The destination addresses of the descriptors associated with the second image may start at 5120×0×3+2560×3, increase to 5120×1×3+2560×3, and then continue to increase until reaching 5120×1439×3+2560×3. The destination addresses of the descriptors associated with the third image may start at 5120×1440×3, increase to 5120×1441×3, and then continue to increase until reaching 5120×2879×3. The destination addresses of the descriptors associated with the fourth image may start at 5120×1440×3+2560×3, increase to 5120×1441×3+2560×3, and then continue to increase until reaching 5120×2879×3+2650×3.

Referring back to the example of FIG. 1, in some examples, the process 100 may be used to perform additional and/or alternative types of image processing on the image data 104 other than image stitching. For instance, in some examples, the process 100 may be used to perform image cropping on one or more of the images represented by the image data 104. In such examples, the descriptors 112 associated with the image being cropped may be used to transmit only a portion of the image data 104, such as the portion of the image data 104 representing the cropped portion of the image, without transmitting one or more other portions of the image data 104. For example, the descriptors 112 may include at least source addresses indicating the locations within a source memory 108 for which the portion of the image data 104 is located and destination addresses indicating locations within the destination memory 118 for storing the portion of the image data 104.

Additionally, in some examples, the process 100 may be used to overlay images with respect to one another. In such examples, a first descriptor 112 associated with the first source memory 108(1) may be associated with transmitting first image data 104(1) representing an entire first image and a second descriptor 112 associated with the second source memory 108(2) may be associated with transmitted a portion of second image data 104(1) representing a portion of a second image. Additionally, the portion of the second image may be overlayed over the first image based on the transmitting. For example, the first image data 104(1) and the portion of the second image data 104(2) may be stored in the destination memory 118 using the descriptors 112 in a way that creates the overlay image where the portion of the second image is overlayed over the first image. For instance, the first descriptor 112 may indicate a first portion of the destination memory 118 while the second descriptor 112 indicates a second portion of the destination memory 118 that is within the first portion of the destination memory 118.

Furthermore, in some examples, the process 100 may be used to perform texture overlaying of images. For instance, in some examples, a first descriptor 112 associated with the first source memory 108(1) may be associated with transmitting first image data 104(1) representing an entire first image using a first channel and then a second descriptor 112 associated with the second source memory 108(2) may be associated with transmitting second image data 104(2) representing an entire second image using a second channel. Based on how the image data 104 is stored in the destination memory 118, the second image may be overlayed over a portion of the first image. Additionally, or alternatively, in some examples, a first descriptor 112 associated with the first source memory 108(1) may be associated with transmitting only a portion of the first image data 104(1) that is associated with a portion of the first image for which the second image is not overlayed while the second descriptor 112 is still associated with transmitting the entire second image. Again, based on how the image data 104 is stored in the destination memory 118, the second image may be overlayed over the first image.

Moreover, in some examples, the process 100 may be used to convert images, such as from block linear to pitch linear conversion or from pitch linear to block linear conversion. In such examples, the descriptors 112 may again be used to retrieve the image data 104 from the source memories 108 and store the image data 104 in the destination memory 118 in locations that are associated with the conversion.

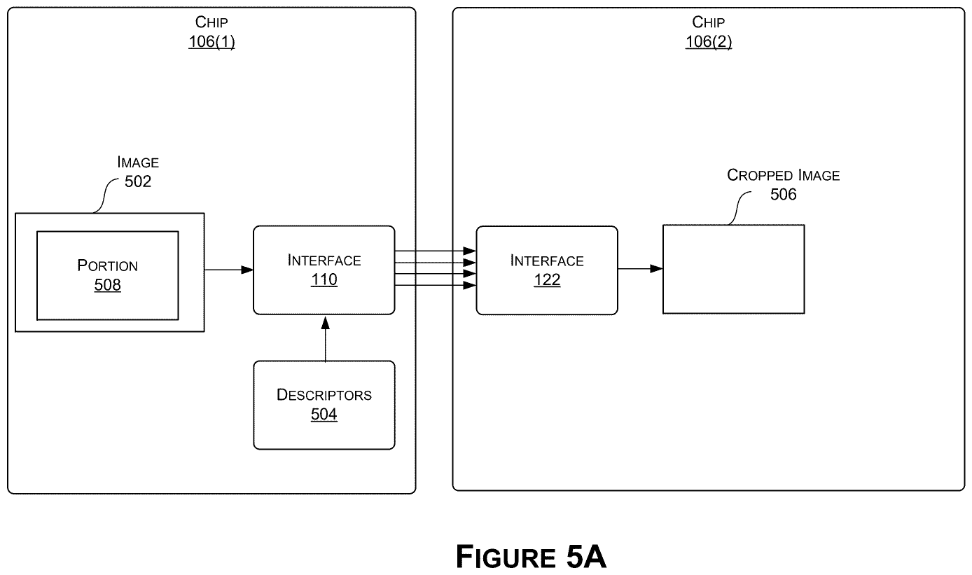

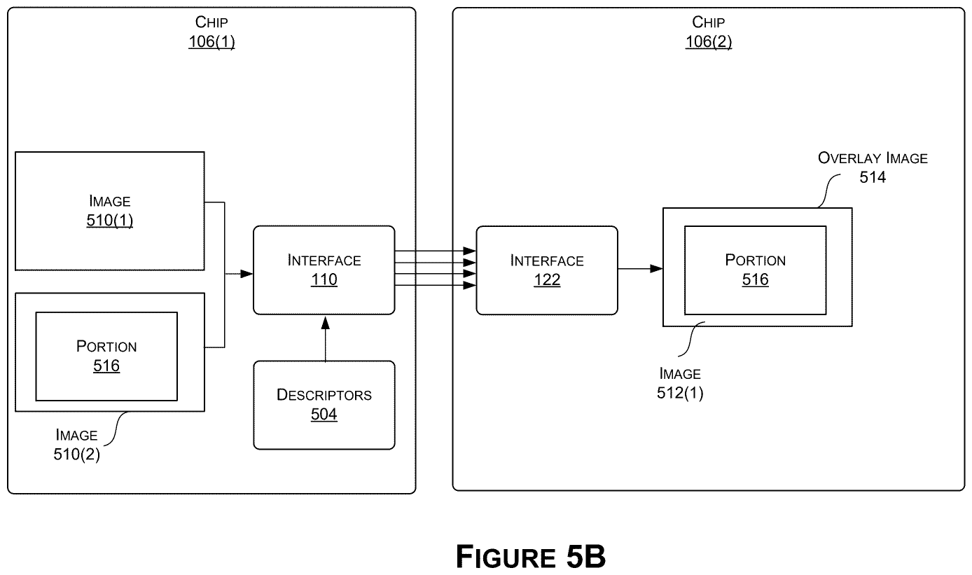

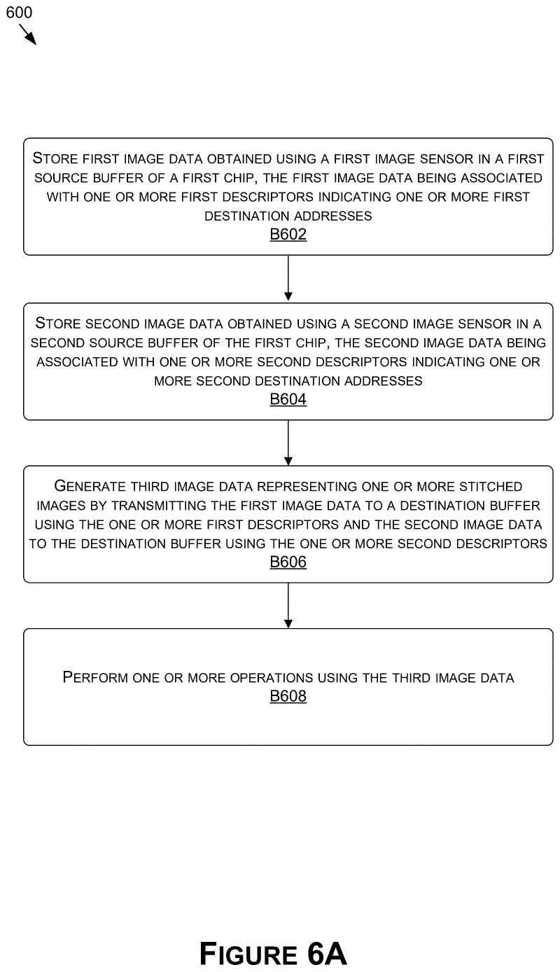

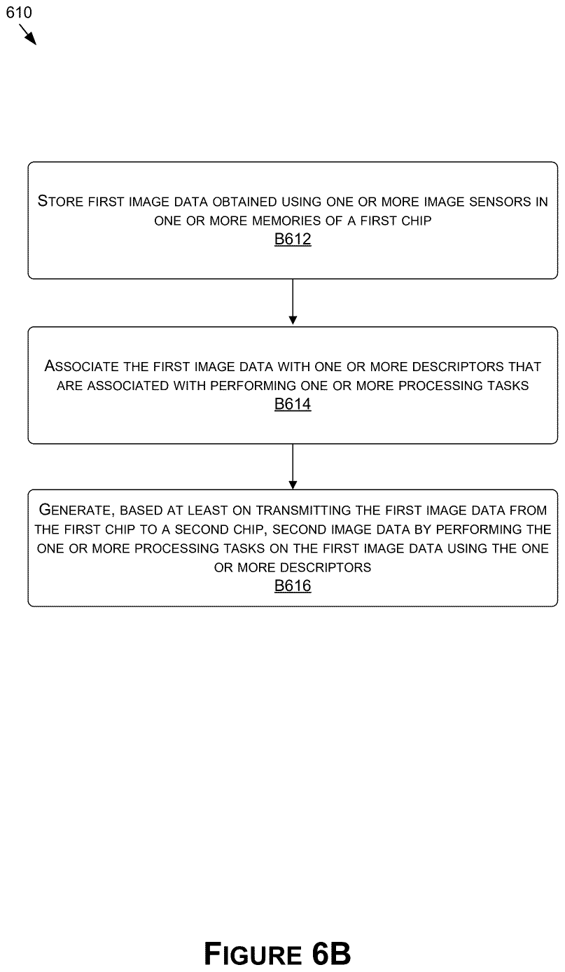

For instance, FIGS. 5A-5B illustrate examples of additional processing that may be performed to images using one or more of the processes described herein, in accordance with some embodiments of the present disclosure. As shown, by the example of FIG. 6A, the first chip 106(1) may store image data representing an image 502 in a source memory 108 (which is not illustrated for clarity reasons). For instance, in some examples, the first image sensor 204(1) may obtain the image data representing the image 502 stored in the first source memory 108(1). The first chip 106(1) may also associate the image 502 with one or more descriptors 504 (which may include, and/or be similar to, the descriptors 112) used for generating a cropped image 506. For instance, the descriptor(s) 504 may indicate a portion of the source memory 108 that corresponds to a portion 508 of the image 502 that corresponds to the cropped image 506. As such, the descriptor(s) 504 may be used to just transfer a portion of the image data representing the portion 508 of the image 502.

As shown by the example of FIG. 6B, the first chip 106(1) may store image data representing images 510(1)-(2) (also referred to singularly as “image 510” or in plural as “images 510”) in source memories 108 (which are not illustrated for clarity reasons). For instance, in some examples, the first image sensor 104(1) may obtain first image data representing the first image 510(1) stored in the first source memory 108(1) and the second image sensor 104(2) may obtain second image data representing the second image 510(2) stored in the second source memory 108(2). The first chip 106(1) may also associate the images 510 with descriptors 512 (which may include, and/or be similar to, the descriptors 112) used for generating an overlay image 514. For instance, the descriptors 512 may cause an entirety of the first image data to be transmitted and a portion of the second image data representing a portion 516 of the second image 510(2) to be transmitted. Additionally, the descriptors 512 may cause the portion 516 of the second image 510(2) to be overlayed at a specific portion of the first image 510(1).

Referring back to the example of FIG. 1, the process 100 may then include performing one or more operations using one or more components 124. For instance, in some examples, a component 124 may include a display device and the operation(s) may include displaying the processed images, such as the stitched images represented by the images data stored in the destination memory 118, using the display device. However, in other examples, a component 124 may include a system, a machine learning model, a neural network, an algorithm, a module, a processor, and/or any other type of processing component that is configured to process the image data stored in the destination memory 118. For instance, the component 124 may process the image data to perform one or more tasks, such as object detection, object tracking, object classification, event detection, event classification, and/or any other type of processing task.

Although not illustrated in the example of FIG. 1, one or more of the chips 106 may include additional hardware and/or software for processing the image data 104. For example, the first chip 106(1) may include additional memories, such as buffers, that initially store the image data 104 obtained using the image sensors 102. The image data 104 stored in the additional memories may then be processed using one or more processing components, such as before being stored in the source memories 108. In other words, while the example of FIG. 1 only illustrates the processing that is performed to the image data 104 during the transmission of the image data 104 from the first chip 106(1) to the second chip 106(2), in other examples, additional processing may be performed on the image data 104 using additional hardware and/or software associated with the chips 106.

While the examples of FIGS. 1-5B describe using four image sensors to obtain image data that is then processed, in other examples, similar processes may be used to process image data obtained using any number of image sensors. For example, similar processes may be used to process image data obtained using two image sensors in order to horizontally and/or vertically stitch the images captured using the image sensors.

Now referring to FIGS. 6A-6B, each block of methods 600 and 610, described herein, comprises a computing process that may be performed using any combination of hardware, firmware, and/or software. For instance, various functions may be carried out by a processor executing instructions stored in memory. The methods 600 and 610 may also be embodied as computer-usable instructions stored on computer storage media. The methods 600 and 610 may be provided by a standalone application, a service or hosted service (standalone or in combination with another hosted service), or a plug-in to another product, to name a few. In addition, these methods 600 and 610 described, by way of example, with respect to FIG. 1. However, these methods 600 and 610 may additionally or alternatively be executed by any one system, or any combination of systems, including, but not limited to, those described herein.

FIG. 6A illustrates a flow diagram showing a method 600 for using data transmission to perform image stitching, in accordance with some embodiments of the present disclosure. The method 600, at block B602, may include storing first image data obtained using a first image sensor in a first source buffer of a first chip, the first image data being associated with one or more first descriptors indicating one or more first destination addresses. For instance, the first image sensor 102(1) may be used to obtain the first image data 104(1) representing one or more first images. The first image data 104(1) may then be stored in the first source memory 108(1) of the first chip 106(1), where the first image data 104(1), the first source memory 108(1), and/or a first channel may be associated with the first descriptor(s) 112 that indicates the first destination address(es).

The method 600, at block B604, may include storing second image data obtained using a second image sensor in a second source buffer of the first chip, the second image data being associated with one or more second descriptors indicating one or more second destination addresses. For instance, the second image sensor 102(2) may be used to obtain the second image data 104(2) representing one or more second images. The second image data 104(2) may then be stored in the second source memory 108(2) of the first chip 106(1), where the second image data 104(1), the second source memory 108(2), and/or a second channel may be associated with the second descriptor(s) 112 that indicates the second destination address(es).

The method 600, at block B606, may include generating third image data representing one or more stitched images by transmitting the first image data to a destination buffer using the one or more first descriptors and the second image data to the destination buffer using the one or more second descriptors. For instance, the first chip 106(1) may transmit the first image data 104(1) to a first portion of the destination memory 118 using the first descriptor(s) 112 and the second image data 104(2) to a second portion of the destination memory 118 using the second descriptor(s) 112. As described herein, performing such transmitting may stitch the first image(s) with respect to the second image(s) to generate the third image data representing the stitched image(s). Additionally, the stitching may include vertical stitching, horizontal stitching, grid stitching, and/or any other type of stitching.

The method 600, at block B608, may include performing one or more operations using the third image data. For instance, in some examples, the operation(s) may include at least displaying the stitched image(s) using a display device, where the display device may include a component 124. However, in other examples, other types of operations may be performed using the third image data, such as by processing the third image data using one or more image processing techniques.

FIG. 6B illustrates a flow diagram showing a method 610 for using descriptors to perform one or more processing tasks when transmitting data between chips, in accordance with some embodiments of the present disclosure. The method 610, at block B612, may include storing first image data obtained using one or more image sensors in one or more memories of a first chip. For instance, the image sensor(s) 102 may obtain the first image data 104, where the first image data 104 represents one or more images. As described herein, in some examples, the image sensor(s) 102 may be associated with an object, such as a machine, and/or an environment. The first chip 106(1) may then store the first image data 104 in one or more of the source memories 108.

The method 610, at block B614, may include associating the first image data with one or more descriptors that are associated with performing one or more processing tasks. For instance, the first image data 104 may be associated with the descriptor(s) 112. As described herein, the descriptor(s) 112 may include information that is associated with performing the processing task(s), such as image stitching, image cropping, format conversion, and/or any other type of processing task. For example, the descriptor(s) 112 may include at least one or more source addresses 116 for one or more locations for retrieving the first image data 104 and one destination addresses 116 for one or more locations for storing the first image data 104.

The method 610, at block B616, may include generating, based at least on transmitting the first image data from the first chip to a second chip, second image data by performing the one or more processing tasks on the first image data using the one or more descriptors. For instance, the first chip 106(1) (e.g., the interface 110) may use the descriptor(s) 112 to transmit the first image data 104 to the second chip 106(2), such as for storage in the destination memory 118. By transmitting the first image data 104 using the information from the descriptor(s) 112, the first image data 104 may be processed using the processing task(s) in order to generate the second image data 104. For example, the second image data 104 may represent one or more stitched images, one or more cropped images, a different image format, and/or some other type of processed image.

### Example Autonomous Vehicle

FIG. 7A is an illustration of an example autonomous vehicle 700, in accordance with some embodiments of the present disclosure. The autonomous vehicle 700 (alternatively referred to herein as the “vehicle 700”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 700 may be capable of functionality in accordance with one or more of Level 3-Level 5 of the autonomous driving levels. The vehicle 700 may be capable of functionality in accordance with one or more of Level 1-Level 5 of the autonomous driving levels. For example, the vehicle 700 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 700 or other machine, such as being fully autonomous, being highly autonomous, being conditionally autonomous, being partially autonomous, providing assistive autonomy, being semi-autonomous, being primarily autonomous, or other designation.

The vehicle 700 may include components such as a chassis, a vehicle body, wheels (e.g., 2, 4, 6, 8, 18, etc.), tires, axles, and other components of a vehicle. The vehicle 700 may include a propulsion system 750, such as an internal combustion engine, hybrid electric power plant, an all-electric engine, and/or another propulsion system type. The propulsion system 750 may be connected to a drive train of the vehicle 700, which may include a transmission, to enable the propulsion of the vehicle 700. The propulsion system 750 may be controlled in response to receiving signals from the throttle/accelerator 752.

A steering system 754, which may include a steering wheel, may be used to steer the vehicle 700 (e.g., along a desired path or route) when the propulsion system 750 is operating (e.g., when the vehicle is in motion). The steering system 754 may receive signals from a steering actuator 756. The steering wheel may be optional for full automation (Level 5) functionality.

The brake sensor system 746 may be used to operate the vehicle brakes in response to receiving signals from the brake actuators 748 and/or brake sensors.

Controller(s) 736, which may include one or more system on chips (SoCs) 704 (FIG. 7C) and/or GPU(s), may provide signals (e.g., representative of commands) to one or more components and/or systems of the vehicle 700. For example, the controller(s) may send signals to operate the vehicle brakes via one or more brake actuators 748, to operate the steering system 754 via one or more steering actuators 756, to operate the propulsion system 750 via one or more throttle/accelerators 752. The controller(s) 736 may include one or more onboard (e.g., integrated) computing devices (e.g., supercomputers) that process sensor signals, and output operation commands (e.g., signals representing commands) to enable autonomous driving and/or to assist a human driver in driving the vehicle 700. The controller(s) 736 may include a first controller 736 for autonomous driving functions, a second controller 736 for functional safety functions, a third controller 736 for artificial intelligence functionality (e.g., computer vision), a fourth controller 736 for infotainment functionality, a fifth controller 736 for redundancy in emergency conditions, and/or other controllers. In some examples, a single controller 736 may handle two or more of the above functionalities, two or more controllers 736 may handle a single functionality, and/or any combination thereof.

The controller(s) 736 may provide the signals for controlling one or more components and/or systems of the vehicle 700 in response to sensor data received from one or more sensors (e.g., sensor inputs). The sensor data may be received from, for example and without limitation, global navigation satellite systems (“GNSS”) sensor(s) 758 (e.g., Global Positioning System sensor(s)), RADAR sensor(s) 760, ultrasonic sensor(s) 762, LIDAR sensor(s) 764, inertial measurement unit (IMU) sensor(s) 766 (e.g., accelerometer(s), gyroscope(s), magnetic compass(es), magnetometer(s), etc.), microphone(s) 796, stereo camera(s) 768, wide-view camera(s) 770 (e.g., fisheye cameras), infrared camera(s) 772, surround camera(s) 774 (e.g., 360 degree cameras), long-range and/or mid-range camera(s) 798, speed sensor(s) 744 (e.g., for measuring the speed of the vehicle 700), vibration sensor(s) 742, steering sensor(s) 740, brake sensor(s) (e.g., as part of the brake sensor system 746), and/or other sensor types.

One or more of the controller(s) 736 may receive inputs (e.g., represented by input data) from an instrument cluster 732 of the vehicle 700 and provide outputs (e.g., represented by output data, display data, etc.) via a human-machine interface (HMI) display 734, an audible annunciator, a loudspeaker, and/or via other components of the vehicle 700. The outputs may include information such as vehicle velocity, speed, time, map data (e.g., the High Definition (“HD”) map 722 of FIG. 7C), location data (e.g., the vehicle's 700 location, such as on a map), direction, location of other vehicles (e.g., an occupancy grid), information about objects and status of objects as perceived by the controller(s) 736, etc. For example, the HMI display 734 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 700 further includes a network interface 724 which may use one or more wireless antenna(s) 726 and/or modem(s) to communicate over one or more networks. For example, the network interface 724 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 726 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 7B is an example of camera locations and fields of view for the example autonomous vehicle 700 of FIG. 7A, in accordance with some embodiments of the present disclosure. The cameras and respective fields of view are one example embodiment and are not intended to be limiting. For example, additional and/or alternative cameras may be included and/or the cameras may be located at different locations on the vehicle 700.

The camera types for the cameras may include, but are not limited to, digital cameras that may be adapted for use with the components and/or systems of the vehicle 700. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 700 (e.g., front-facing cameras) may be used for surround view, to help identify forward facing paths and obstacles, as well aid in, with the help of one or more controllers 736 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 770 that may be used to perceive objects coming into view from the periphery (e.g., pedestrians, crossing traffic or bicycles). Although only one wide-view camera is illustrated in FIG. 7B, there may be any number (including zero) of wide-view cameras 770 on the vehicle 700. In addition, any number of long-range camera(s) 798 (e.g., a long-view stereo camera pair) may be used for depth-based object detection, especially for objects for which a neural network has not yet been trained. The long-range camera(s) 798 may also be used for object detection and classification, as well as basic object tracking.

Any number of stereo cameras 768 may also be included in a front-facing configuration. In at least one embodiment, one or more of stereo camera(s) 768 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 768 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 768 may be used in addition to, or alternatively from, those described herein.

Cameras with a field of view that include portions of the environment to the side of the vehicle 700 (e.g., side-view cameras) may be used for surround view, providing information used to create and update the occupancy grid, as well as to generate side impact collision warnings. For example, surround camera(s) 774 (e.g., four surround cameras 774 as illustrated in FIG. 7B) may be positioned to on the vehicle 700. The surround camera(s) 774 may include wide-view camera(s) 770, fisheye camera(s), 360 degree camera(s), and/or the like. Four example, four fisheye cameras may be positioned on the vehicle's front, rear, and sides. In an alternative arrangement, the vehicle may use three surround camera(s) 774 (e.g., left, right, and rear), and may leverage one or more other camera(s) (e.g., a forward-facing camera) as a fourth surround view camera.

Cameras with a field of view that include portions of the environment to the rear of the vehicle 700 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 798, stereo camera(s) 768), infrared camera(s) 772, etc.), as described herein.

FIG. 7C is a block diagram of an example system architecture for the example autonomous vehicle 700 of FIG. 7A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 700 in FIG. 7C are illustrated as being connected via bus 702. The bus 702 may include a Controller Area Network (CAN) data interface (alternatively referred to herein as a “CAN bus”). A CAN may be a network inside the vehicle 700 used to aid in control of various features and functionality of the vehicle 700, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 702 is described herein as being a CAN bus, this is not intended to be limiting. For example, in addition to, or alternatively from, the CAN bus, FlexRay and/or Ethernet may be used. Additionally, although a single line is used to represent the bus 702, this is not intended to be limiting. For example, there may be any number of busses 702, which may include one or more CAN busses, one or more FlexRay busses, one or more Ethernet busses, and/or one or more other types of busses using a different protocol. In some examples, two or more busses 702 may be used to perform different functions, and/or may be used for redundancy. For example, a first bus 702 may be used for collision avoidance functionality and a second bus 702 may be used for actuation control. In any example, each bus 702 may communicate with any of the components of the vehicle 700, and two or more busses 702 may communicate with the same components. In some examples, each SoC 704, each controller 736, and/or each computer within the vehicle may have access to the same input data (e.g., inputs from sensors of the vehicle 700), and may be connected to a common bus, such the CAN bus.

The vehicle 700 may include one or more controller(s) 736, such as those described herein with respect to FIG. 7A. The controller(s) 736 may be used for a variety of functions. The controller(s) 736 may be coupled to any of the various other components and systems of the vehicle 700, and may be used for control of the vehicle 700, artificial intelligence of the vehicle 700, infotainment for the vehicle 700, and/or the like.

The vehicle 700 may include a system(s) on a chip (SoC) 704. The SoC 704 may include CPU(s) 706, GPU(s) 708, processor(s) 710, cache(s) 712, accelerator(s) 714, data store(s) 716, and/or other components and features not illustrated. The SoC(s) 704 may be used to control the vehicle 700 in a variety of platforms and systems. For example, the SoC(s) 704 may be combined in a system (e.g., the system of the vehicle 700) with an HD map 722 which may obtain map refreshes and/or updates via a network interface 724 from one or more servers (e.g., server(s) 778 of FIG. 7D).

The CPU(s) 706 may include a CPU cluster or CPU complex (alternatively referred to herein as a “CCPLEX”). The CPU(s) 706 may include multiple cores and/or L2 caches. For example, in some embodiments, the CPU(s) 706 may include eight cores in a coherent multi-processor configuration. In some embodiments, the CPU(s) 706 may include four dual-core clusters where each cluster has a dedicated L2 cache (e.g., a 2 MB L2 cache). The CPU(s) 706 (e.g., the CCPLEX) may be configured to support simultaneous cluster operation enabling any combination of the clusters of the CPU(s) 706 to be active at any given time.

The CPU(s) 706 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 706 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 708 may include an integrated GPU (alternatively referred to herein as an “iGPU”). The GPU(s) 708 may be programmable and may be efficient for parallel workloads. The GPU(s) 708, in some examples, may use an enhanced tensor instruction set. The GPU(s) 708 may include one or more streaming microprocessors, where each streaming microprocessor may include an L1 cache (e.g., an L1 cache with at least 96KB storage capacity), and two or more of the streaming microprocessors may share an L2 cache (e.g., an L2 cache with a 512 KB storage capacity). In some embodiments, the GPU(s) 708 may include at least eight streaming microprocessors. The GPU(s) 708 may use compute application programming interface(s) (API(s)). In addition, the GPU(s) 708 may use one or more parallel computing platforms and/or programming models (e.g., NVIDIA's CUDA).

The GPU(s) 708 may be power-optimized for best performance in automotive and embedded use cases. For example, the GPU(s) 708 may be fabricated on a Fin field-effect transistor (FinFET). However, this is not intended to be limiting and the GPU(s) 708 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 708 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 708 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 708 to access the CPU(s) 706 page tables directly. In such examples, when the GPU(s) 708 memory management unit (MMU) experiences a miss, an address translation request may be transmitted to the CPU(s) 706. In response, the CPU(s) 706 may look in its page tables for the virtual-to-physical mapping for the address and transmits the translation back to the GPU(s) 708. As such, unified memory technology may allow a single unified virtual address space for memory of both the CPU(s) 706 and the GPU(s) 708, thereby simplifying the GPU(s) 708 programming and porting of applications to the GPU(s) 708.

In addition, the GPU(s) 708 may include an access counter that may keep track of the frequency of access of the GPU(s) 708 to memory of other processors. The access counter may help ensure that memory pages are moved to the physical memory of the processor that is accessing the pages most frequently.

The SoC(s) 704 may include any number of cache(s) 712, including those described herein. For example, the cache(s) 712 may include an L3 cache that is available to both the CPU(s) 706 and the GPU(s) 708 (e.g., that is connected both the CPU(s) 706 and the GPU(s) 708). The cache(s) 712 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 704 may include an arithmetic logic unit(s) (ALU(s)) which may be leveraged in performing processing with respect to any of the variety of tasks or operations of the vehicle 700—such as processing DNNs. In addition, the SoC(s) 704 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 706 and/or GPU(s) 708.

The SoC(s) 704 may include one or more accelerators 714 (e.g., hardware accelerators, software accelerators, or a combination thereof). For example, the SoC(s) 704 may include a hardware acceleration cluster that may include optimized hardware accelerators and/or large on-chip memory. The large on-chip memory (e.g., 4MB of SRAM), may enable the hardware acceleration cluster to accelerate neural networks and other calculations. The hardware acceleration cluster may be used to complement the GPU(s) 708 and to off-load some of the tasks of the GPU(s) 708 (e.g., to free up more cycles of the GPU(s) 708 for performing other tasks). As an example, the accelerator(s) 714 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 714 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 708, and by using an inference accelerator, for example, a designer may target either the DLA(s) or the GPU(s) 708 for any function. For example, the designer may focus processing of CNNs and floating point operations on the DLA(s) and leave other functions to the GPU(s) 708 and/or other accelerator(s) 714.

The accelerator(s) 714 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 706. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 714 (e.g., the hardware acceleration cluster) may include a computer vision network on-chip and SRAM, for providing a high-bandwidth, low latency SRAM for the accelerator(s) 714. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 704 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 714 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 766 output that correlates with the vehicle 700 orientation, distance, 3D location estimates of the object obtained from the neural network and/or other sensors (e.g., LIDAR sensor(s) 764 or RADAR sensor(s) 760), among others.

The SoC(s) 704 may include data store(s) 716 (e.g., memory). The data store(s) 716 may be on-chip memory of the SoC(s) 704, which may store neural networks to be executed on the GPU and/or the DLA. In some examples, the data store(s) 716 may be large enough in capacity to store multiple instances of neural networks for redundancy and safety. The data store(s) 712 may comprise L2 or L3 cache(s) 712. Reference to the data store(s) 716 may include reference to the memory associated with the PVA, DLA, and/or other accelerator(s) 714, as described herein.

The SoC(s) 704 may include one or more processor(s) 710 (e.g., embedded processors). The processor(s) 710 may include a boot and power management processor that may be a dedicated processor and subsystem to handle boot power and management functions and related security enforcement. The boot and power management processor may be a part of the SoC(s) 704 boot sequence and may provide runtime power management services. The boot power and management processor may provide clock and voltage programming, assistance in system low power state transitions, management of SoC(s) 704 thermals and temperature sensors, and/or management of the SoC(s) 704 power states. Each temperature sensor may be implemented as a ring-oscillator whose output frequency is proportional to temperature, and the SoC(s) 704 may use the ring-oscillators to detect temperatures of the CPU(s) 706, GPU(s) 708, and/or accelerator(s) 714. If temperatures are determined to exceed a threshold, the boot and power management processor may enter a temperature fault routine and put the SoC(s) 704 into a lower power state and/or put the vehicle 700 into a chauffeur to safe stop mode (e.g., bring the vehicle 700 to a safe stop).

The processor(s) 710 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 710 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 710 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 710 may further include a real-time camera engine that may include a dedicated processor subsystem for handling real-time camera management.

The processor(s) 710 may further include a high-dynamic range signal processor that may include an image signal processor that is a hardware engine that is part of the camera processing pipeline.

The processor(s) 710 may include a video image compositor that may be a processing block (e.g., implemented on a microprocessor) that implements video post-processing functions needed by a video playback application to produce the final image for the player window. The video image compositor may perform lens distortion correction on wide-view camera(s) 770, surround camera(s) 774, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 708 is not required to continuously render new surfaces. Even when the GPU(s) 708 is powered on and active doing 3D rendering, the video image compositor may be used to offload the GPU(s) 708 to improve performance and responsiveness.

The SoC(s) 704 may further include a mobile industry processor interface (MIPI) camera serial interface for receiving video and input from cameras, a high-speed interface, and/or a video input block that may be used for camera and related pixel input functions. The SoC(s) 704 may further include an input/output controller(s) that may be controlled by software and may be used for receiving I/O signals that are uncommitted to a specific role.

The SoC(s) 704 may further include a broad range of peripheral interfaces to enable communication with peripherals, audio codecs, power management, and/or other devices. The SoC(s) 704 may be used to process data from cameras (e.g., connected over Gigabit Multimedia Serial Link and Ethernet), sensors (e.g., LIDAR sensor(s) 764, RADAR sensor(s) 760, etc. that may be connected over Ethernet), data from bus 702 (e.g., speed of vehicle 700, steering wheel position, etc.), data from GNSS sensor(s) 758 (e.g., connected over Ethernet or CAN bus). The SoC(s) 704 may further include dedicated high-performance mass storage controllers that may include their own DMA engines, and that may be used to free the CPU(s) 706 from routine data management tasks.

The SoC(s) 704 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 704 may be faster, more reliable, and even more energy-efficient and space-efficient than conventional systems. For example, the accelerator(s) 714, when combined with the CPU(s) 706, the GPU(s) 708, and the data store(s) 716, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 720) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 708.

In some examples, a CNN for facial recognition and vehicle owner identification may use data from camera sensors to identify the presence of an authorized driver and/or owner of the vehicle 700. The always on sensor processing engine may be used to unlock the vehicle when the owner approaches the driver door and turn on the lights, and, in security mode, to disable the vehicle when the owner leaves the vehicle. In this way, the SoC(s) 704 provide for security against theft and/or carjacking.

In another example, a CNN for emergency vehicle detection and identification may use data from microphones 796 to detect and identify emergency vehicle sirens. In contrast to conventional systems, that use general classifiers to detect sirens and manually extract features, the SoC(s) 704 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 758. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 762, until the emergency vehicle(s) passes.

The vehicle may include a CPU(s) 718 (e.g., discrete CPU(s), or dCPU(s)), that may be coupled to the SoC(s) 704 via a high-speed interconnect (e.g., PCIe). The CPU(s) 718 may include an X86 processor, for example. The CPU(s) 718 may be used to perform any of a variety of functions, including arbitrating potentially inconsistent results between ADAS sensors and the SoC(s) 704, and/or monitoring the status and health of the controller(s) 736 and/or infotainment SoC 730, for example.

The vehicle 700 may include a GPU(s) 720 (e.g., discrete GPU(s), or dGPU(s)), that may be coupled to the SoC(s) 704 via a high-speed interconnect (e.g., NVIDIA's NVLINK). The GPU(s) 720 may provide additional artificial intelligence functionality, such as by executing redundant and/or different neural networks, and may be used to train and/or update neural networks based on input (e.g., sensor data) from sensors of the vehicle 700.

The vehicle 700 may further include the network interface 724 which may include one or more wireless antennas 726 (e.g., one or more wireless antennas for different communication protocols, such as a cellular antenna, a Bluetooth antenna, etc.). The network interface 724 may be used to enable wireless connectivity over the Internet with the cloud (e.g., with the server(s) 778 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 700 information about vehicles in proximity to the vehicle 700 (e.g., vehicles in front of, on the side of, and/or behind the vehicle 700). This functionality may be part of a cooperative adaptive cruise control functionality of the vehicle 700.

The network interface 724 may include a SoC that provides modulation and demodulation functionality and enables the controller(s) 736 to communicate over wireless networks. The network interface 724 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 700 may further include data store(s) 728 which may include off-chip (e.g., off the SoC(s) 704) storage. The data store(s) 728 may include one or more storage elements including RAM, SRAM, DRAM, VRAM, Flash, hard disks, and/or other components and/or devices that may store at least one bit of data.

The vehicle 700 may further include GNSS sensor(s) 758. The GNSS sensor(s) 758 (e.g., GPS, assisted GPS sensors, differential GPS (DGPS) sensors, etc.), to assist in mapping, perception, occupancy grid generation, and/or path planning functions. Any number of GNSS sensor(s) 758 may be used, including, for example and without limitation, a GPS using a USB connector with an Ethernet to Serial (RS-232) bridge.

The vehicle 700 may further include RADAR sensor(s) 760. The RADAR sensor(s) 760 may be used by the vehicle 700 for long-range vehicle detection, even in darkness and/or severe weather conditions. RADAR functional safety levels may be ASIL B. The RADAR sensor(s) 760 may use the CAN and/or the bus 702 (e.g., to transmit data generated by the RADAR sensor(s) 760) for control and to access object tracking data, with access to Ethernet to access raw data in some examples. A wide variety of RADAR sensor types may be used. For example, and without limitation, the RADAR sensor(s) 760 may be suitable for front, rear, and side RADAR use. In some example, Pulse Doppler RADAR sensor(s) are used.

The RADAR sensor(s) 760 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 760 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 700 surroundings at higher speeds with minimal interference from traffic in adjacent lanes. The other two antennae may expand the field of view, making it possible to quickly detect vehicles entering or leaving the vehicle's 700 lane.

Mid-range RADAR systems may include, as an example, a range of up to 760 m (front) or 80 m (rear), and a field of view of up to 42 degrees (front) or 750 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 700 may further include ultrasonic sensor(s) 762. The ultrasonic sensor(s) 762, which may be positioned at the front, back, and/or the sides of the vehicle 700, may be used for park assist and/or to create and update an occupancy grid. A wide variety of ultrasonic sensor(s) 762 may be used, and different ultrasonic sensor(s) 762 may be used for different ranges of detection (e.g., 2.5 m, 4 m). The ultrasonic sensor(s) 762 may operate at functional safety levels of ASIL B.

The vehicle 700 may include LIDAR sensor(s) 764. The LIDAR sensor(s) 764 may be used for object and pedestrian detection, emergency braking, collision avoidance, and/or other functions. The LIDAR sensor(s) 764 may be functional safety level ASIL B. In some examples, the vehicle 700 may include multiple LIDAR sensors 764 (e.g., two, four, six, etc.) that may use Ethernet (e.g., to provide data to a Gigabit Ethernet switch).

In some examples, the LIDAR sensor(s) 764 may be capable of providing a list of objects and their distances for a 360-degree field of view. Commercially available LIDAR sensor(s) 764 may have an advertised range of approximately 700 m, with an accuracy of 2 cm-3 cm, and with support for a 700 Mbps Ethernet connection, for example. In some examples, one or more non-protruding LIDAR sensors 764 may be used. In such examples, the LIDAR sensor(s) 764 may be implemented as a small device that may be embedded into the front, rear, sides, and/or corners of the vehicle 700. The LIDAR sensor(s) 764, in such examples, may provide up to a 120-degree horizontal and 35-degree vertical field-of-view, with a 200 m range even for low-reflectivity objects. Front-mounted LIDAR sensor(s) 764 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 700. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 764 may be less susceptible to motion blur, vibration, and/or shock.

The vehicle may further include IMU sensor(s) 766. The IMU sensor(s) 766 may be located at a center of the rear axle of the vehicle 700, in some examples. The IMU sensor(s) 766 may include, for example and without limitation, an accelerometer(s), a magnetometer(s), a gyroscope(s), a magnetic compass(es), and/or other sensor types. In some examples, such as in six-axis applications, the IMU sensor(s) 766 may include accelerometers and gyroscopes, while in nine-axis applications, the IMU sensor(s) 766 may include accelerometers, gyroscopes, and magnetometers.

In some embodiments, the IMU sensor(s) 766 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 766 may enable the vehicle 700 to estimate heading without requiring input from a magnetic sensor by directly observing and correlating the changes in velocity from GPS to the IMU sensor(s) 766. In some examples, the IMU sensor(s) 766 and the GNSS sensor(s) 758 may be combined in a single integrated unit.

The vehicle may include microphone(s) 796 placed in and/or around the vehicle 700. The microphone(s) 796 may be used for emergency vehicle detection and identification, among other things.

The vehicle may further include any number of camera types, including stereo camera(s) 768, wide-view camera(s) 770, infrared camera(s) 772, surround camera(s) 774, long-range and/or mid-range camera(s) 798, and/or other camera types. The cameras may be used to capture image data around an entire periphery of the vehicle 700. The types of cameras used depends on the embodiments and requirements for the vehicle 700, and any combination of camera types may be used to provide the necessary coverage around the vehicle 700. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 7A and FIG. 7B.

The vehicle 700 may further include vibration sensor(s) 742. The vibration sensor(s) 742 may measure vibrations of components of the vehicle, such as the axle(s). For example, changes in vibrations may indicate a change in road surfaces. In another example, when two or more vibration sensors 742 are used, the differences between the vibrations may be used to determine friction or slippage of the road surface (e.g., when the difference in vibration is between a power-driven axle and a freely rotating axle).

The vehicle 700 may include an ADAS system 738. The ADAS system 738 may include a SoC, in some examples. The ADAS system 738 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 760, LIDAR sensor(s) 764, and/or a camera(s). The ACC systems may include longitudinal ACC and/or lateral ACC. Longitudinal ACC monitors and controls the distance to the vehicle immediately ahead of the vehicle 700 and automatically adjust the vehicle speed to maintain a safe distance from vehicles ahead. Lateral ACC performs distance keeping, and advises the vehicle 700 to change lanes when necessary. Lateral ACC is related to other ADAS applications such as LCA and CWS.

CACC uses information from other vehicles that may be received via the network interface 724 and/or the wireless antenna(s) 726 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 700), while the I2V communication concept provides information about traffic further ahead. CACC systems may include either or both I2V and V2V information sources. Given the information of the vehicles ahead of the vehicle 700, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 760, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 760, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 700 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 700 if the vehicle 700 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 760, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 700 is backing up. Some RCTW systems include AEB to ensure that the vehicle brakes are applied to avoid a crash. RCTW systems may use one or more rear-facing RADAR sensor(s) 760, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 700, the vehicle 700 itself must, in the case of conflicting results, decide whether to heed the result from a primary computer or a secondary computer (e.g., a first controller 736 or a second controller 736). For example, in some embodiments, the ADAS system 738 may be a backup and/or secondary computer for providing perception information to a backup computer rationality module. The backup computer rationality monitor may run a redundant diverse software on hardware components to detect faults in perception and dynamic driving tasks. Outputs from the ADAS system 738 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 704.

In other examples, ADAS system 738 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 738 may be fed into the primary computer's perception block and/or the primary computer's dynamic driving task block. For example, if the ADAS system 738 indicates a forward crash warning due to an object immediately ahead, the perception block may use this information when identifying objects. In other examples, the secondary computer may have its own neural network which is trained and thus reduces the risk of false positives, as described herein.

The vehicle 700 may further include the infotainment SoC 730 (e.g., an in-vehicle infotainment system (IVI)). Although illustrated and described as a SoC, the infotainment system may not be a SoC, and may include two or more discrete components. The infotainment SoC 730 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 700. For example, the infotainment SoC 730 may radios, disk players, navigation systems, video players, USB and Bluetooth connectivity, carputers, in-car entertainment, Wi-Fi, steering wheel audio controls, hands free voice control, a heads-up display (HUD), an HMI display 734, a telematics device, a control panel (e.g., for controlling and/or interacting with various components, features, and/or systems), and/or other components. The infotainment SoC 730 may further be used to provide information (e.g., visual and/or audible) to a user(s) of the vehicle, such as information from the ADAS system 738, autonomous driving information such as planned vehicle maneuvers, trajectories, surrounding environment information (e.g., intersection information, vehicle information, road information, etc.), and/or other information.

The infotainment SoC 730 may include GPU functionality. The infotainment SoC 730 may communicate over the bus 702 (e.g., CAN bus, Ethernet, etc.) with other devices, systems, and/or components of the vehicle 700. In some examples, the infotainment SoC 730 may be coupled to a supervisory MCU such that the GPU of the infotainment system may perform some self-driving functions in the event that the primary controller(s) 736 (e.g., the primary and/or backup computers of the vehicle 700) fail. In such an example, the infotainment SoC 730 may put the vehicle 700 into a chauffeur to safe stop mode, as described herein.

The vehicle 700 may further include an instrument cluster 732 (e.g., a digital dash, an electronic instrument cluster, a digital instrument panel, etc.). The instrument cluster 732 may include a controller and/or supercomputer (e.g., a discrete controller or supercomputer). The instrument cluster 732 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 730 and the instrument cluster 732. In other words, the instrument cluster 732 may be included as part of the infotainment SoC 730, or vice versa.

FIG. 7D is a system diagram for communication between cloud-based server(s) and the example autonomous vehicle 700 of FIG. 7A, in accordance with some embodiments of the present disclosure. The system 776 may include server(s) 778, network(s) 790, and vehicles, including the vehicle 700. The server(s) 778 may include a plurality of GPUs 784(A)-784(H) (collectively referred to herein as GPUs 784), PCIe switches 782(A)-782(H) (collectively referred to herein as PCIe switches 782), and/or CPUs 780(A)-780(B) (collectively referred to herein as CPUs 780). The GPUs 784, the CPUs 780, and the PCIe switches may be interconnected with high-speed interconnects such as, for example and without limitation, NVLink interfaces 788 developed by NVIDIA and/or PCIe connections 786. In some examples, the GPUs 784 are connected via NVLink and/or NVSwitch SoC and the GPUs 784 and the PCIe switches 782 are connected via PCIe interconnects. Although eight GPUs 784, two CPUs 780, and two PCIe switches are illustrated, this is not intended to be limiting. Depending on the embodiment, each of the server(s) 778 may include any number of GPUs 784, CPUs 780, and/or PCIe switches. For example, the server(s) 778 may each include eight, sixteen, thirty-two, and/or more GPUs 784.

The server(s) 778 may receive, over the network(s) 790 and from the vehicles, image data representative of images showing unexpected or changed road conditions, such as recently commenced road-work. The server(s) 778 may transmit, over the network(s) 790 and to the vehicles, neural networks 792, updated neural networks 792, and/or map information 794, including information regarding traffic and road conditions. The updates to the map information 794 may include updates for the HD map 722, such as information regarding construction sites, potholes, detours, flooding, and/or other obstructions. In some examples, the neural networks 792, the updated neural networks 792, and/or the map information 794 may have resulted from new training and/or experiences represented in data received from any number of vehicles in the environment, and/or based on training performed at a datacenter (e.g., using the server(s) 778 and/or other servers).

The server(s) 778 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 790, and/or the machine learning models may be used by the server(s) 778 to remotely monitor the vehicles.

In some examples, the server(s) 778 may receive data from the vehicles and apply the data to up-to-date real-time neural networks for real-time intelligent inferencing. The server(s) 778 may include deep-learning supercomputers and/or dedicated AI computers powered by GPU(s) 784, such as a DGX and DGX Station machines developed by NVIDIA. However, in some examples, the server(s) 778 may include deep learning infrastructure that use only CPU-powered datacenters.

The deep-learning infrastructure of the server(s) 778 may be capable of fast, real-time inferencing, and may use that capability to evaluate and verify the health of the processors, software, and/or associated hardware in the vehicle 700. For example, the deep-learning infrastructure may receive periodic updates from the vehicle 700, such as a sequence of images and/or objects that the vehicle 700 has located in that sequence of images (e.g., via computer vision and/or other machine learning object classification techniques). The deep-learning infrastructure may run its own neural network to identify the objects and compare them with the objects identified by the vehicle 700 and, if the results do not match and the infrastructure concludes that the AI in the vehicle 700 is malfunctioning, the server(s) 778 may transmit a signal to the vehicle 700 instructing a fail-safe computer of the vehicle 700 to assume control, notify the passengers, and complete a safe parking maneuver.

For inferencing, the server(s) 778 may include the GPU(s) 784 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). In other words, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a simulated image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that enable the computing device 800 to communicate with other computing devices via an electronic communication network, included wired and/or wireless communications. The communication interface 810 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may enable the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that enable detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to enable the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### Example Data Center

FIG. 9 illustrates an example data center 900 that may be used in at least one embodiments of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) may correspond to a server having one or more of the above-mentioned computing resources. In addition, in some embodiments, the node C.R.s 916(1)-9161(N) may include one or more virtual components, such as vGPUs, vCPUs, and/or the like, and/or one or more of the node C.R.s 916(1)-916(N) may correspond to a virtual machine (VM).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-916(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, as shown in FIG. 9, framework layer 920 may include a job scheduler 933, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 933 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 933. In at least one embodiment, clustered or grouped computing resources may include grouped computing resource 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: storing first image data obtained using a first image sensor in a first source buffer of a first system-on-a-chip (SoC), the first image data associated with one or more first descriptors indicating one or more first source addresses associated with the first source buffer and one or more first destination addresses associated with a destination buffer; storing second image data obtained using a second image sensor in a second source buffer of the first SoC, the second image data associated with one or more second descriptors indicating one or more second source addresses associated with the second source buffer and one or more second destination addresses associated with the destination buffer; generating third image data representing one or more stitched images by at least: transmitting the first image data to a first portion of the destination buffer of a second SoC using the one or more first descriptors; and transmitting the second image data to a second portion of the destination buffer of the second SoC using the one or more second descriptors; and performing one or more operations using the third image data.
B: The method of paragraph A, wherein: the one or more first descriptors further indicate at least one of one more first identifiers of the one or more first descriptors or one or more first lengths associated with transmitting the first image data; and the one or more second descriptors further indicate at least one of one more second identifiers associated with the one or more second descriptors or one or more second lengths associated with transmitting the second image data.
C: The method of either paragraph A or paragraph B, wherein: the one or more first descriptors include at least a first descriptor that includes a first source address associated with an entirety of the first source buffer and a first destination address associated with an entirety of the first portion of the destination buffer; and the one or more second descriptors include at least a second descriptor that includes a second source address associated with an entirety of the second source buffer and a second destination address associated with an entirety of the second portion of the destination buffer.
D: The method of any one of paragraphs A-C, wherein: the one or more first source addresses associated with the one or more first descriptors include a plurality of first source addresses, an individual first source address of the plurality of first source addresses being associated with a respective line of the first source buffer; the one or more first destination addresses associated with the one or more first descriptors include a plurality of first destination addresses, an individual first destination address of the plurality of first destination addresses being associated with a respective line of the first portion of the destination buffer; the one or more second source addresses associated with the one or more second descriptors include a plurality of second source addresses, an individual second source address of the plurality of second source addresses being associated with a respective line of the second source buffer; and the one or more second destination addresses associated with the one or more second descriptors include a plurality of second destination addresses, an individual second destination address of the plurality of second destination addresses being associated with a respective line of the second portion of the destination buffer.
E: The method of any one of paragraphs A-D, wherein: the first source buffer and the second source buffer are included in a first dynamic random access memory of the first chip; a first Peripheral Component Interconnect Express of the first SoC transmits the first image data and the second image data; the destination buffer is included in a second dynamic random access memory of the second chip; and a second Peripheral Component Interconnect Express of the second SoC receives the first image data and the second image data.
F: The method of any one of paragraphs A-E, wherein: the transmitting the first image data uses a first channel; and the transmitting of the second image data uses a second channel and occurs asynchronously with the transmitting of the first image data.
G: The method of any one of paragraphs A-F, wherein: the first image data represents one or more first images; the second image data represents one or more second images; and the one or more stitched images include at least one of: the one or more first images vertically stitched to the one or more second images; or the one or more first images horizontally stitched to the one or more second images.
H: The method of any one of paragraphs A-G, wherein the performing the one or more operations using the third image data comprises at least one of: causing, using the third image data, a display of the one or more stitched images; sending the third image data to one or more computing devices; or processing the third image data.
I: A system comprising: one or more processors to: store, in one or more source buffers of a first chip, first image data generated using image sensors of a machine, the first image data being associated with one or more descriptors indicating at least one or more destination addresses; transmit, using the destination addresses, the first image data from the one or more source buffers to a destination buffer of a second chip to generate second image data representing one or more processed images; and perform one or more operations using the second image data.
J: The system of paragraph I, wherein the one or more descriptors further indicate at least one of one or more identifiers associated with the descriptors, one or more source addresses associated with the source buffers, or one or more lengths associated with transmitting the first image data.
K: The system of either paragraph I or paragraph J, wherein: the transmission of the first image data comprises: transmitting, using one or more first descriptors of the one or more descriptors, a first portion of the first image data from a first source buffer of the one or more source buffers to a first portion of the destination buffer; and transmitting, using one or more second descriptors of the one or more descriptors, a second portion of the first image data from a second source buffer of the one or more source buffers to a second portion of the destination buffer; and the one or more processed images include one or more stitched images.
L: The system of paragraph K, wherein: the one or more first descriptors include a first destination address of the one or more destination addresses that is associated with an entirety of the first portion of the destination buffer; and the one or more second descriptors include a second destination address of the one or more destination addresses that is associated with an entirety of the second portion of the destination buffer.
M: The system of paragraph L, wherein: the first portion of the first image data represents one or more first images; the second portion of the first image data represents one or more second images; and the one or more stitched images include at least the one or more first images vertically stitched to the one or more second images based at least on the first destination address being associated with the entirety of the first portion of the destination buffer and the second destination address being associated with the entirety of the second portion of the destination address.
N: The system of paragraph K, wherein: the one or more first descriptors include a plurality of first descriptors, an individual first descriptor of the plurality of first descriptors including a respective destination addresses of the one or more destination addresses that is associated with a respective line of the first portion of the destination buffer; and the one or more second descriptors include a plurality of second descriptors, an individual second descriptor of the plurality of second descriptors including a respective destination addresses of the one or more destination addresses that is associated with a respective line of the second portion of the destination buffer.
O: The system of paragraph N, wherein: the first portion of the first image data represents one or more first images; the second portion of the first image data represents one or more second images; and the one or more stitched images include at least the one or more first images horizontally stitched to the one or more second images based at least on the individual first descriptor including the respective destination address that is associated with the respective line of the first portion of the destination buffer and the individual second descriptor including the respective destination address that is associated with the respective line of the second portion of the destination buffer.
P: The system of any one of paragraphs I-O wherein: the transmission of the first image data comprises: transmitting, using one or more first descriptors of the one or more descriptors, a first portion of the first image data from a first source buffer of the one or more source buffers to a first portion of the destination buffer; and transmitting, using one or more second descriptors of the one or more descriptors, a second portion of the first image data from a second source buffer of the one or more source buffers to a second portion of the destination buffer, the second portion of the destination buffer including some of the first portion of the destination buffer; and the one or more processed images include one or more overlay images.
Q: The system of any one of paragraphs I-P wherein: the first image data is stored in a source buffer of the one or more source buffers; the transmission of the first image data comprises transmitting, using the one or more descriptors, a portion of the first image data from the source buffer to the destination buffer; and the one or more processed images include one or more cropped images.
R: The system of any one of paragraphs I-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.
S: One or more processors comprising: processing circuitry to: generate first image data representing one or more processed images based at least on transmitting second image data stored in one or more source buffers of a first chip to a destination buffer of a second chip, wherein the second image data is transmitted from the one or more source buffers to the destination buffer using at least one or more descriptors indicating one or more source addresses associated with the one or more source buffers and one or more destination addresses associated with the destination buffer.
T: The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

What is claimed is:

1. A method comprising:
storing first image data obtained using a first image sensor in a first source buffer of a first system-on-a-chip (SoC), the first image data associated with one or more first descriptors indicating one or more first source addresses associated with the first source buffer and one or more first destination addresses associated with a destination buffer;
storing second image data obtained using a second image sensor in a second source buffer of the first SoC, the second image data associated with one or more second descriptors indicating one or more second source addresses associated with the second source buffer and one or more second destination addresses associated with the destination buffer;
generating third image data representing one or more stitched images by at least:
transmitting the first image data to a first portion of the destination buffer of a second SoC using the one or more first descriptors; and
transmitting the second image data to a second portion of the destination buffer of the second SoC using the one or more second descriptors; and
performing one or more operations using the third image data.

2. The method of claim 1, wherein:
the one or more first descriptors further indicate at least one of one more first identifiers of the one or more first descriptors or one or more first lengths associated with transmitting the first image data; and
the one or more second descriptors further indicate at least one of one more second identifiers associated with the one or more second descriptors or one or more second lengths associated with transmitting the second image data.

3. The method of claim 1, wherein:
the one or more first descriptors include at least a first descriptor that includes a first source address associated with an entirety of the first source buffer and a first destination address associated with an entirety of the first portion of the destination buffer; and
the one or more second descriptors include at least a second descriptor that includes a second source address associated with an entirety of the second source buffer and a second destination address associated with an entirety of the second portion of the destination buffer.

4. The method of claim 1, wherein:
the one or more first source addresses associated with the one or more first descriptors include a plurality of first source addresses, an individual first source address of the plurality of first source addresses being associated with a respective line of the first source buffer;
the one or more first destination addresses associated with the one or more first descriptors include a plurality of first destination addresses, an individual first destination address of the plurality of first destination addresses being associated with a respective line of the first portion of the destination buffer;
the one or more second source addresses associated with the one or more second descriptors include a plurality of second source addresses, an individual second source address of the plurality of second source addresses being associated with a respective line of the second source buffer; and
the one or more second destination addresses associated with the one or more second descriptors include a plurality of second destination addresses, an individual second destination address of the plurality of second destination addresses being associated with a respective line of the second portion of the destination buffer.

5. The method of claim 1, wherein:
the first source buffer and the second source buffer are included in a first dynamic random access memory of the first chip;
a first Peripheral Component Interconnect Express of the first SoC transmits the first image data and the second image data;
the destination buffer is included in a second dynamic random access memory of the second chip; and
a second Peripheral Component Interconnect Express of the second SoC receives the first image data and the second image data.

6. The method of claim 1, wherein:
the transmitting the first image data uses a first channel; and
the transmitting of the second image data uses a second channel and occurs asynchronously with the transmitting of the first image data.

7. The method of claim 1, wherein:
the first image data represents one or more first images;
the second image data represents one or more second images; and
the one or more stitched images include at least one of:
the one or more first images vertically stitched to the one or more second images; or
the one or more first images horizontally stitched to the one or more second images.

8. The method of claim 1, wherein the performing the one or more operations using the third image data comprises at least one of:
causing, using the third image data, a display of the one or more stitched images;
sending the third image data to one or more computing devices; or
processing the third image data.

9. A system comprising:
one or more processors to:
store, in one or more source buffers of a first chip, first image data generated using image sensors of a machine, the first image data being associated with one or more descriptors indicating at least one or more destination addresses;
transmit, using the destination addresses, the first image data from the one or more source buffers to a destination buffer of a second chip to generate second image data representing one or more processed images; and
perform one or more operations using the second image data.

10. The system of claim 9, wherein the one or more descriptors further indicate at least one of one or more identifiers associated with the descriptors, one or more source addresses associated with the source buffers, or one or more lengths associated with transmitting the first image data.

11. The system of claim 9, wherein:
the transmission of the first image data comprises:
transmitting, using one or more first descriptors of the one or more descriptors, a first portion of the first image data from a first source buffer of the one or more source buffers to a first portion of the destination buffer; and
transmitting, using one or more second descriptors of the one or more descriptors, a second portion of the first image data from a second source buffer of the one or more source buffers to a second portion of the destination buffer; and
the one or more processed images include one or more stitched images.

12. The system of claim 11, wherein:
the one or more first descriptors include a first destination address of the one or more destination addresses that is associated with an entirety of the first portion of the destination buffer; and
the one or more second descriptors include a second destination address of the one or more destination addresses that is associated with an entirety of the second portion of the destination buffer.

13. The system of claim 12, wherein:
the first portion of the first image data represents one or more first images;
the second portion of the first image data represents one or more second images; and
the one or more stitched images include at least the one or more first images vertically stitched to the one or more second images based at least on the first destination address being associated with the entirety of the first portion of the destination buffer and the second destination address being associated with the entirety of the second portion of the destination address.

14. The system of claim 11, wherein:
the one or more first descriptors include a plurality of first descriptors, an individual first descriptor of the plurality of first descriptors including a respective destination addresses of the one or more destination addresses that is associated with a respective line of the first portion of the destination buffer; and
the one or more second descriptors include a plurality of second descriptors, an individual second descriptor of the plurality of second descriptors including a respective destination addresses of the one or more destination addresses that is associated with a respective line of the second portion of the destination buffer.

15. The system of claim 14, wherein:
the first portion of the first image data represents one or more first images;
the second portion of the first image data represents one or more second images; and
the one or more stitched images include at least the one or more first images horizontally stitched to the one or more second images based at least on the individual first descriptor including the respective destination address that is associated with the respective line of the first portion of the destination buffer and the individual second descriptor including the respective destination address that is associated with the respective line of the second portion of the destination buffer.

16. The system of claim 9, wherein:
the transmission of the first image data comprises:
transmitting, using one or more first descriptors of the one or more descriptors, a first portion of the first image data from a first source buffer of the one or more source buffers to a first portion of the destination buffer; and
transmitting, using one or more second descriptors of the one or more descriptors, a second portion of the first image data from a second source buffer of the one or more source buffers to a second portion of the destination buffer, the second portion of the destination buffer including some of the first portion of the destination buffer; and
the one or more processed images include one or more overlay images.

17. The system of claim 9, wherein:
the first image data is stored in a source buffer of the one or more source buffers;
the transmission of the first image data comprises transmitting, using the one or more descriptors, a portion of the first image data from the source buffer to the destination buffer; and
the one or more processed images include one or more cropped images.

18. The system of claim 9. wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

19. One or more processors comprising:
processing circuitry to:
generate first image data representing one or more processed images based at least on transmitting second image data stored in one or more source buffers of a first chip to a destination buffer of a second chip, wherein the second image data is transmitted from the one or more source buffers to the destination buffer using at least one or more descriptors indicating one or more source addresses associated with the one or more source buffers and one or more destination addresses associated with the destination buffer.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
